(19) United States
(12) Patent Application Publication
(10) Pub. No.: US 2025/0347801 A1
(43) Pub. Date: Nov. 13, 2025

(54) METHOD AND DEVICE FOR TRANSMITTING DATA USING UWB COMMUNICATION

(71) Applicants: SAMSUNG ELECTRONICS CO., LTD., Suwon-si (KR); GEOPLAN CO., LTD, Anyang-si (KR)

(72) Inventors: Junyoung CHOI, Suwon-si (KR); Jisung KIM, Anyang-si (KR); Jinwook SEO, Suwon-si (KR); Joohyun LEE, Suwon-si (KR); Byunghyun JEON, Anyang-si (KR); Dongyeong EUN, Anyang-si (KR); Sangjin LEE, Anyang-si (KR)

(21) Appl. No.: 19/204,204

(22) Filed: May 9, 2025

(30) Foreign Application Priority Data
May 10, 2024 (KR) 10-2024-0062083

(51) Int. Cl. G01S 13/76

(52) U.S. Cl. CPC G01S 13/765

(57) ABSTRACT

A method of a first ultra-wide band (UWB) device according to an embodiment of the disclosure may comprise exchanging at least one message for downlink time-difference-of-arrival (DL-TDoA) with a second UWB device in a first period, receiving a first message for two-way ranging (TWR) from the second UWB device in a second period for a hybrid UWB session (HUS), and transmitting a second message for the TWR to the second UWB device in a third period for the HUS. A different session ID may be allocated to each of the second period and the third period for the HUS.

### CROSS-REFERENCE TO RELATED APPLICATION

This application is based on and claims priority under 35 U.S.C. § 119 to Korean Patent Application No. 10-2024-0062083, which was filed in the Korean Intellectual Property Office on May 10, 2024, the entire disclosure of which is incorporated herein by reference.

### BACKGROUND

### 1. Field

The disclosure relates to an ultra-wide band (UWB) communication and, more specifically, to a data transmission method and device using a UWB communication.

### 2. Description of Related Art

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. The IoT may be implemented with technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, healthcare, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB). UWB is a wireless communication technology that uses a very wide frequency band of several GHz or more in a baseband without using a wireless carrier.

### SUMMARY

The disclosure provides a method for efficiently utilizing a ranging resource by performing hybrid ranging in an ultra-wide band (UWB)-based system.

A method of a first ultra-wide band (UWB) device according to an embodiment of the disclosure may comprise exchanging at least one message for downlink time-difference-of-arrival (DL-TDoA) with a second UWB device in a first period, receiving a first message for two-way ranging (TWR) from the second UWB device in a second period for a hybrid UWB session (HUS), and transmitting a second message for the TWR to the second UWB device in a third period for the HUS. A different session ID may be allocated to each of the second period and the third period for the HUS.

A method of a second ultra-wide band (UWB) device according to an embodiment of the disclosure may comprise exchanging at least one message for downlink time-difference-of-arrival (DL-TDoA) with a first UWB device in a first period, transmitting a first message for two-way ranging (TWR) to the first UWB device in a second period for a hybrid UWB session (HUS), and receiving a second message for the TWR from the first UWB device in a third period for the HUS. A different session ID may be allocated to each of the second period and the third period for the HUS.

The UWB device according to an embodiment of the disclosure may efficiently utilize a ranging resource by performing hybrid ranging using ranging rounds included in at least one ranging block.

Further, the UWB device according to an embodiment of the disclosure may efficiently manage service time by performing hybrid ranging using ranging rounds included in at least one ranging block.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates an example architecture of a UWB device according to an embodiment of the disclosure;

FIG. 2 illustrates an example configuration of a communication system including a UWB device according to an embodiment of the disclosure;

FIGS. 3A and 3B illustrate an example structure of a frame used for UWB communication according to an embodiment of the disclosure;

FIG. 4 illustrates a method for performing UWB communication by two UWB devices according to an embodiment of the disclosure;

FIGS. 5A and 5B illustrate a method for performing UWB ranging by two UWB devices according to an embodiment of the disclosure;

FIG. 6A illustrates a structure of a ranging block and a round used for UWB ranging according to an embodiment of the disclosure;

FIG. 6B illustrates a structure of a ranging round used for hybrid ranging according to an embodiment of the disclosure;

FIG. 7 illustrates an example of data exchange using HUS according to an embodiment of the disclosure;

FIG. 8 illustrates an example of message exchange according to an embodiment of the disclosure;

FIG. 9 illustrates an example of data exchange using an HUS according to an embodiment of the disclosure;

FIGS. 10A and 10B illustrate an example of adjusting a length of a CBR phase considering a processing time according to an embodiment of the disclosure;

FIGS. 11A and 11B illustrate an example of segmentation according to a message length according to an embodiment of the disclosure;

FIG. 12 illustrates an example of configuring a TWR phase in a multi-gate multi-user circumstance according to an embodiment of the disclosure;

FIGS. 13A and 13B illustrate examples of data segmentation according to an embodiment of the disclosure;

FIGS. 14A and 14B illustrate examples of data segmentation according to an embodiment of the disclosure;

FIGS. 15A and 15B illustrate examples of transmitting a segmented message according to an embodiment of the disclosure;

FIGS. 16A and 16B illustrate examples of transmitting a segmented message according to an embodiment of the disclosure;

FIGS. 17A and 17B illustrate examples of transmitting a segmented message according to an embodiment of the disclosure;

FIGS. 18A and 18B illustrate an example of performing UWB communication through a multi-channel according to an embodiment of the disclosure;

FIG. 19 illustrates an example of a synchronization session for an HUS operation according to an embodiment of the disclosure;

FIGS. 20A and 20B illustrate an example of performing UWB communication in a single-aisle scenario according to an embodiment of the disclosure;

FIGS. 21A and 21B illustrate an example of performing UWB communication in a single-aisle scenario according to an embodiment of the disclosure;

FIGS. 22A and 22B illustrate an example of performing UWB communication in a multi-aisle scenario according to an embodiment of the disclosure;

FIGS. 23A and 23B illustrate an example of performing UWB communication in a multi-aisle scenario according to an embodiment of the disclosure;

FIG. 24 illustrates a structure of a first UWB device according to an embodiment of the disclosure; and

FIG. 25 illustrates a structure of a second UWB device according to an embodiment of the disclosure.

### DETAILED DESCRIPTION

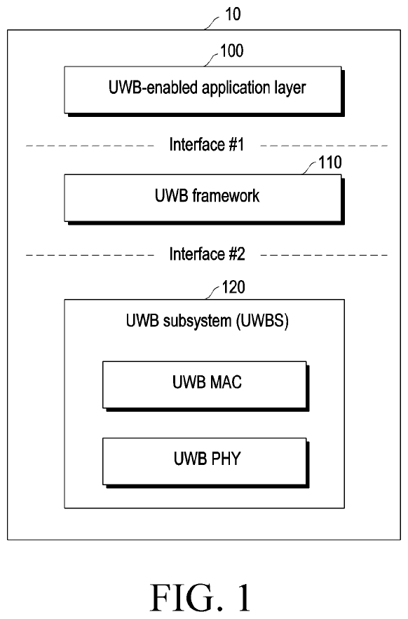

FIGS. 1 through 25, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings.

In describing embodiments, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments of the disclosure, a “ . . . unit” may include one or more processors.

As used herein, the term “terminal” or “device” may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the disclosure and may be replaced with other terms according to the intention or practice of the user or operator. Therefore, the terms should be defined based on the overall disclosure.

Hereinafter, embodiments of the disclosure are described in detail with reference to the accompanying drawings. Further, although a communication system using UWB is described in connection with embodiments of the disclosure, as an example, embodiments of the disclosure may also apply to other communication systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Application dedicated file (ADF)” may be, e.g., a data structure in an application data structure that may host an application or application specific data.

“Application protocol data unit (APDU)” may be a command and a response used when communicating with the application data structure in the UWB device.

“Application specific data” may be, e.g., a file structure having a root level and an application level including UWB controlee information and UWB session data for a UWB session.

“Controller” may be a ranging device that defines and controls ranging control messages (RCM) (or control messages).

“Controlee” may be a ranging device using a ranging parameter in the RCM (or control message) received from the controller.

Unlike “static STS,” “dynamic scrambled timestamp sequence (STS) mode” may be an operation mode in which the STS is not repeated during a ranging session. In this mode, the STS may be managed by the ranging device, and the ranging session key that generates STS may be managed by a secure component.

“Applet” may be an applet executed on the secure component including UWB parameters and service data. In this disclosure, applet may be a FiRa applet defined by FiRa.

“Ranging device” may be a device capable of performing UWB ranging. In the disclosure, the ranging device may be an enhanced ranging device (ERDEV) defined in IEEE 802.15.4z or a FiRa Device defined by FiRa. The ranging device may be referred to as a UWB device.

“UWB-enabled application” may be an application for UWB service. For example, the UWB-enabled application may be an application using a framework API for configuring an OOB connector, a secure service, and/or a UWB service for a UWB session. In this disclosure, “UWB-enabled application” may be abbreviated as an application or a UWB application. UWB-enabled application may be a FiRa-enabled application defined by FiRa.

“Framework” may be a component that provides access to Profiles, individual-UWB configuration and/or notifications. “Framework” may be, e.g., a collection of logical software components including profile manager, OOB connector, secure service, and/or UWB service. In the disclosure, the framework may be a FiRa framework defined by FiRa.

“OOB connector” may be a software component for establishing an out-of-band (OOB) connection (e.g., BLE connection) between ranging devices. In the disclosure, the OOB connector may be a FiRa OOB connector defined by FiRa.

“Profile” may be a previously defined set of UWB and OOB configuration parameters. In the disclosure, profile may be a FiRa profile defined by FiRa.

“Profile manager” may be a software component that implements a profile available on the ranging device. In the disclosure, the profile manager may be a FiRa profile manager defined by FiRa.

“Service” may be an implementation of a use case that provides a service to an end-user.

“Smart ranging device” may be a ranging device that may implement an optional framework API. In the disclosure, the smart ranging device may be a FiRa smart device defined by FiRa.

“Global dedicated file (GDF)” may be a root level of application specific data including data for establishing a USB session.

“Framework API” may be an API used by a UWB-enabled application to communicate with the framework.

“Initiator” may be a ranging device that initiates a ranging exchange.

“Object identifier (OID)” may be an identifier of the ADF in the application data structure.

“Out-of-band (OOB)” may be data communication that does not use UWB as an underlying wireless technology.

“Ranging data set (RDS)” may be data (e.g., UWB session key, session ID, etc.) for establishing a UWB session when it is needed to protect confidentiality, authenticity and integrity.

“Responder” may be a ranging device that responds to the initiator in a ranging exchange.

“STS” may be a ciphered sequence for increasing the integrity and accuracy of ranging measurement timestamps. The STS may be generated from the ranging session key.

“Secure channel” may be a data channel that prevents overhearing and tampering.

“Secure component” may be an entity (e.g., SE or TEE) having a defined security level that interfaces with UWBS for the purpose of providing RDS to UWBS, e.g., when dynamic STS is used.

“Secure element (SE)” may be a tamper-resistant secure hardware component that may be used as a secure component in the ranging device.

“Secure ranging” may be ranging based on STS generated through a strong encryption operation.

“Secure service” may be a software component for interfacing with a secure component, such as a secure element or trusted execution environment (TEE).

“Service applet” may be an applet on a secure component that handles service specific transactions.

“Service data” may be data defined by a service provider that needs to be transferred between two ranging devices to implement a service.

“Service provider” may be an entity that defines and provides hardware and software for providing a specific service to an end-user.

“Static STS mode” is an operation mode in which STS is repeated during a session, and does not need to be managed by the secure component.

“Secure UWB service (SUS) applet” may be an applet on the SE that communicates with the applet to retrieve data needed to enable secure UWB sessions with other ranging devices. The SUS applet may transfer corresponding data (information) to the UWBS.

“UWB service” may be a software component that provides access to the UWBS.

“UWB session” may be a period from when the controller and the controlee start communication through UWB until the communication stops. A UWB session may include ranging, data transfer, or both ranging and data transfer.

“UWB session ID” may be an ID (e.g., a 32-bit integer) that identifies the UWB session, shared between the controller and the controller.

“UWB session key” may be a key used to protect the UWB session. The UWB session Key may be used to generate the STS. In this disclosure, the UWB session key may be a UWB ranging session key (URSK), and may be abbreviated as a session key.

“UWB Subsystem (UWBS)” may be a hardware component implementing the UWB PHY and MAC specifications. UWBS may have an interface to framework and an interface to secure component to search for RDS. In this disclosure, the UWB PHY and MAC specifications may be, e.g., FiRa PHY and FiRa MAC specifications defined by FiRa referring to IEEE 802.15.4/4z.

“UWB message” may be a message including a payload information element (IE) transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“Payload IE” may be referred to as a payload information element and may be included in the MAC payload of the UWB MAC frame defined in IEEE 802.15.4/4z. The MAC payload may include a plurality of payload IEs.

“Data transferIE” may be an additional payload IE for transmitting application data. Application data may be data transferred from a framework or application above the UWB MAC layer. The data transfer IE may be used in the procedure for ranging between the initiator and the responder. In this case, the ranging message may include at least one or both of the payload IE for ranging and the data transfer IE for application data transfer. For example, the data transfer IE may be included and transmitted as part of the payload IE of the MAC payload of a ranging initiation message (RIM) for ranging, a ranging response message (RRM), a ranging final message (RFM), a measurement report message (MRM) and ranging result report message (RRRM). The data transfer IE may be transferred as one of a plurality of payload IEs included in the MAC payload of the ranging message. The payload IE of data transfer IE may be configured as shown in Table 1 below. The data transfer IE may distinguish the transferred content according to the data transfer content type, and the data transfer content type may include a payload that refers to general data and may have a data transfer phase control message (DTPCM) that the controller uses to schedule data transfer.

“Scheduled-based ranging” may be used for the ranging round scheduled by the controller for the controlees to transmit RFRAMEs and/or measurement reports in different ranging slots. In this disclosure, scheduling-based ranging may be referred to as time-scheduled ranging. A scheduling mode in which scheduling-based ranging is used may be referred to as a time-scheduled mode.

“Contention-based ranging” may be used when the controller does not know the MAC addresses of controlees participating in the UWB session (ranging session). In contention-based ranging, the controller may be an initiator and may perform ranging with other unknown UWB devices. In this disclosure, the scheduling mode in which contention-based ranging is used may be referred to as a contention-based mode.

The contention-based ranging may be used for the ranging round in which the controller determines the size of the contention access period and indicates the CAP size through a ranging control message. In this disclosure, the contention access period may be referred to as a contention window or a contention window period.

In the contention-based mode, the UWB device may operate as a controller and an initiator, and in this case, the ranging control phase RCP and the ranging initiation phase RIP may be merged into the RIP. In the ranging phase RP, the allocation of the CAP size may determine the CAP period for the responder(s) participating in the corresponding ranging round in units of ranging slots. Each responder may randomly determine one slot in the CAP to transmit a ranging response message RRM. Messages used in contention-based ranging may use SP1 as an RFRAME configuration. In contention-based ranging, the ranging control message transmitted by the controller may be referred to as control message type 2 (CM type 2) or a second ranging control message.

UWB data transfer (or data transfer) is a transmission method in which UWB devices use a ranging round to transfer application data to each other. Data transfer may operate in a data transfer during ranging mode during ranging in which the data transfer IE is added to the ranging message transmitted in the ranging round allocated for ranging, i.e., two-way ranging or one-way ranging or may operate in a data transfer phase mode in which the ranging round is independently used only for data transmission separately from ranging. The data transfer phase may also be referred to as data transfer-only phase or data transfer-only.

In the data transfer phase, the controller may perform scheduling for data transfer by transmitting a data transfer phase control message (DPTCM).

“Hybrid ranging” may be used when there is a known controlee and an unknown controlee. As described above, the known controlee may be a controlee whose MAC address is known to the controller, and the unknown controlee may be a controlee whose MAC address is not known to the controller. In the disclosure, hybrid ranging may be referred to as hybrid-based ranging or hybrid UWB session (HUS).

The ranging round used for hybrid ranging may be referred to as a hybrid ranging round or a hyper UWB session ranging round (HYUS ranging round). The scheduling mode in which hybrid ranging is used may be referred to as a hybrid-based mode. In the hybrid-based mode, the controller may perform ranging with the known controlee in the scheduling-based mode and with the unknown controlee in the contention-based mode.

In order for the controller to drive hybrid ranging, the controller's host may generate UCI commands in the following order so that UWBS (UWB subsystem) may start hybrid ranging.

First, the host creates a session for hybrid ranging. This may be referred to as a primary session. In this case, a hybrid ranging session may be created in a manner to set the scheduled mode as Hybrid-based. The UCI command that creates the primary session may be SESSION_INIT_CMD.

After creating the hybrid ranging session, the host may create a secondary session to run within the hybrid session. The UCI command that creates the secondary session may be SESSION_INIT_CMD. Each secondary session may be set in the same manner as driving data transfer phase, scheduling-based ranging, or contention-based ranging. SESSION_SET_APP_CONFIG_CMD may be used as a UCI command to set detailed operation settings for each secondary session.

To connect the primary and secondary sessions of hybrid ranging, the host may transmit a UCI command to the UWBS to connect the already created primary and secondary sessions.

When determined to make the subject matter of the disclosure unnecessarily unclear, the detailed description of related known functions or features may be skipped in describing the disclosure.

Hereinafter, various embodiments of the disclosure are described with reference to the accompanying drawings.

FIG. 1 illustrates an example architecture of a UWB device according to an embodiment of the present disclosure.

The UWB device (electronic device) 10 of FIG. 1 may be a ranging device supporting UWB ranging (e.g., UWB secure ranging). In an embodiment, the ranging device may be an enhanced ranging device (ERDEV) defined in IEEE 802.15.4z or a FiRa Device defined by FiRa.

In the embodiment of FIG. 1, the UWB device 10 may interact with other UWB devices through a UWB session.

The UWB device 10 may implement a first interface (Interface #1) that is an interface between the UWB-enabled application 100 and the framework 110, and the first interface allows the UWB-enabled application 100 on the UWB device 10 to use the UWB capabilities of the UWB device 10 in a predetermined manner. In an embodiment, the first interface may be a framework API or a proprietary interface, but is not limited thereto.

The UWB device 10 may implement a second interface (Interface #2) that is an interface between the framework 110 and the UWB subsystem (UWBS, 120). In an embodiment, the second interface may be a UWB Command Interface (UCI) or proprietary interface, but is not limited thereto.

Referring to FIG. 1, the UWB device 10 may include a UWB-enabled application 100, a framework 110, and/or a UWBS 120 including a UWB MAC layer and a UWB Physical layer. Depending on the embodiment, some entities may not be included in the UWB device, or additional entities (e.g., security layer) may be further included.

The UWB-enabled application 100 may trigger establishment of a UWB session by UWBS through the first interface. The UWB-enabled application 100 may use one of previously defined profiles (profile). For example, the UWB-enabled application 100 may use one of the profiles defined in FiRa or a custom profile. The UWB-enabled application 100 may use the first interface to handle related events, such as service discovery, ranging notifications, and/or error conditions.

The UWB framework 110 may provide access to Profiles, individual-UWB settings and/or notifications. The UWB framework 110 may be a set of software components. As described above, the UWB-enabled application 100 may interface with the UWB framework 110 through the first interface, and the UWB framework 110 may interface with the UWBS 120 through the second interface.

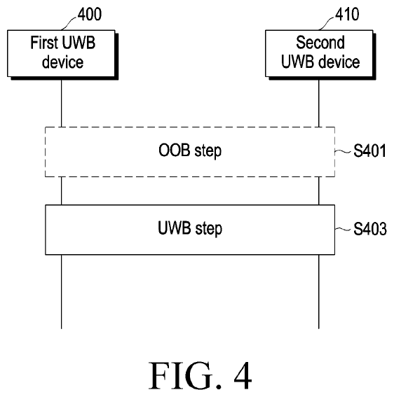

Software components of the UWB framework 110 may include, e.g., profile manager, OOB connector, secure service, and/or UWB service. The profile manager may serve to manage profiles available on the UWB device. Profile may be a set of parameters for establishing a communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. The OOB connector may play a role to establish an OOB connection between UWB devices. The OOB connector may handle an OOB step including a discovery step and a connection step. The OOB step is described below with reference to FIG. 4. The secure service may play a role of interfacing with a secure component, such as SE or TEE. The UWB service may perform a role of managing UWBS. The UWB service may provide access to UWBS from the profile manager by implementing the second interface.

The UWBS 120 may be a hardware component including a UWB MAC layer and a UWB physical layer. The UWBS 120 may perform UWB session management and may communicate with the UWBS of another UWB device. The UWBS 120 may interface with the framework 110 through the second interface and may obtain the RDS from the secure component.

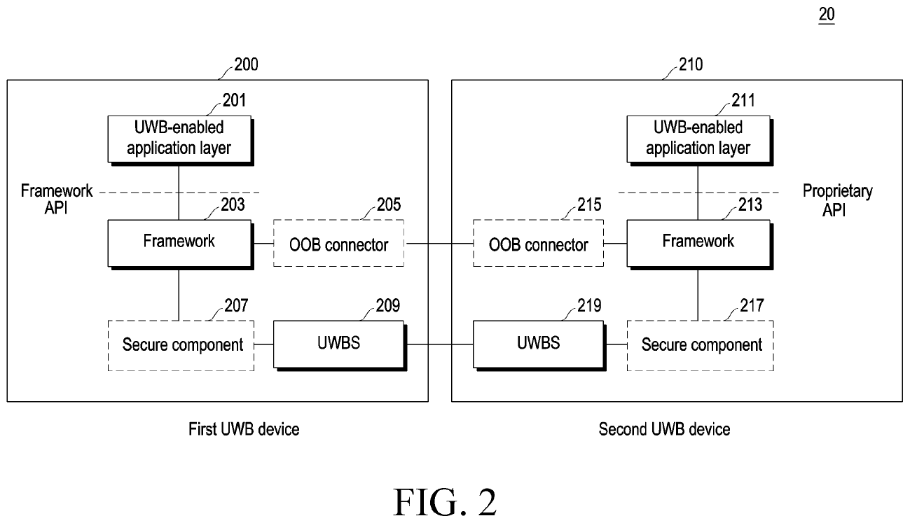

FIG. 2 illustrates an example configuration of a communication system including a UWB device according an embodiment of the present disclosure.

Referring to FIG. 2, the communication system 20 includes a first UWB device 200 and a second UWB device 210. In an embodiment, the first UWB device 200 and the second UWB device 210 may be, e.g., the UWB device 10 of FIG. 1 or an electronic device including the UWB device 10 of FIG. 1.

The first UWB device 200 may host, e.g., one or more UWB-enabled applications 201, which may be installed by the user (e.g., a mobile phone). It may be based on, e.g., the framework API. The second UWB device 210 does not provide a framework API, and for example, may use a proprietary interface to implement a specific UWB-enabled application 211. Unlike shown, according to an embodiment, both the first UWB device 200 and the second UWB device 210 may be ranging devices using the framework API, or both the first UWB device 200 and the second UWB device 210 may be ranging devices using the proprietary interface.

The first UWB device 200 may include a UWB-enabled application layer 201, a framework 203, an OOB component 205, a secure component 207 and/or a UWBS 209. In the disclosure, the OOB component 205 and/or the secure component 207 may be optional components and, according to an embodiment, may not be included in the first UWB device 200.

The second UWB device 210 may include a UWB-enabled application layer 211, a framework 213, an OOB component 215, a secure component 217, and/or a UWBS 219. In the disclosure, the OOB component 215 and/or the secure component 217 may be optional components and, according to an embodiment, may not be included in the second UWB device 210.

The frameworks 203 and 213 may serve to provide access to profiles, individual-UWB settings, and/or notifications. The frameworks 203 and 213 may be a set of software components, and may include, e.g., profile manager, OOB connector, secure service, and/or UWB service. For a description of each component, refer to the above description.

The OOB components 205 and 215 may be hardware components including a MAC layer and/or a physical layer for OOB communication (e.g., BLE communication). The OOB components 205 and 215 may communicate with OOB components of other devices. In an embodiment, the first UWB device 200 and the second UWB device 210 may create an OOB connection (channel) using the OOB components 205 and 215 and exchange parameters for establishing a UWB session through the OOB channel. In this disclosure, the OOB components 205 and 215 may be referred to as OOB subsystems.

The UWBS 209 and 219 may be a hardware component including a UWB MAC layer and a UWB Physical layer. The UWBS 209 and 219 may perform UWB session management and may communicate with the UWBS of another UWB device. In an embodiment, the first UWB device 200 and the second UWB device 210 may perform transaction of service data and UWB ranging through the UWB session established through the UWBSs 209 and 219 using the exchanged parameters.

The secure components 207 and 217 may be hardware components that interface with the framework and/or UWBS to provide RDS.

In the disclosure, the UWB-enabled application layers 201 and 211 and/or the frameworks 203 and 213 may be implemented by an application processor (AP) (or processor). Accordingly, in the disclosure, it may be understood that the operations of the UWB-enabled application layers 201 and 211 and/or the frameworks 203 and 213 are performed by an AP (or a processor).

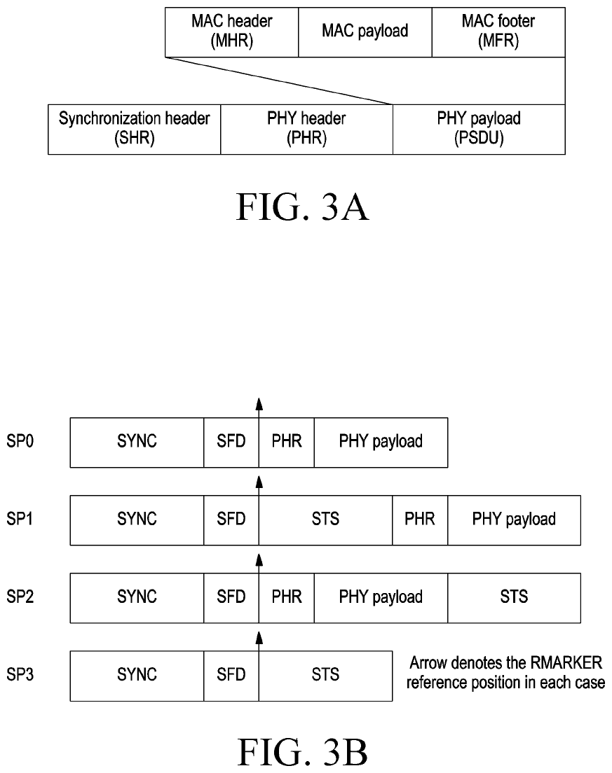

FIGS. 3A and 3B illustrate an example structure of a frame used for UWB communication according to an embodiment of the present disclosure.

FIG. 3A illustrates an example structure of a frame to which the STS packet configuration is not applied, and FIG. 3B illustrates an example structure of a frame to which the STS packet configuration is applied. In an embodiment, the frame may be a ranging frame (RFRAME) for transferring ranging data (e.g., ranging initiation/reply/final message, etc.) or a data frame for transferring other data (e.g., service data, etc.).

Referring to FIG. 3A, the frame or a PHY PDU (PPDU) for transferring the frame may include a synchronization header (SHR), a PHY header (PHR), and a PHY payload (PSDU). The PSDU may include a MAC frame. The MAC frame may include a MAC header (MHR), a MAC payload and/or a MAC footer (MFR). The synchronization header of the PPDU may include a SYNC field and a start-of-frame delimiter (SFD). The SFD field may be a field indicating the end of the SHR and the start of the data field. For a description of each element/field included in the PPDU and MAC frame, refer to the description defined in IEEE 802.15.4/4z and/or FiRa.

Meanwhile, the PHY layer of the UWB device may include an optional mode to provide a reduced on-air time for high density/low power operation. In this case, the frame may include an encrypted sequence (i.e., STS) to increase the integrity and accuracy of the ranging measurement timestamp. The STS may be used for security ranging.

The structure of the PPDU (or frame) when the STS packet setting is applied (supported) may be as shown in FIG. 3B.

Referring to FIG. 3B, in the case of STS packet (SP) setting 0 (SP0), the STS field is not included in the PPDU (SP0 packet). In the case of SP setting 1 (SP1), the STS field is positioned immediately after the Start of Frame Delimiter (SFD) field and before the PHR field (SP1 packet). In the case of SP setting 2 (SP2), the STS field is positioned after the PHY payload (SP2 packet). In the case of SP setting 3 (SP3), the STS field is positioned immediately after the SFD field, and the PPDU does not include the PHR and data field (PHY payload) (SP3 packet). In other words, in the case of SP3, the frame (or UWB message) does not include the PHR and PHY payload.

SP0, SP1 and SP3 may be settings that may be supported as mandatory when the STS packet setting is supported, and SP2 may be an optionally supported setting.

FIG. 4 illustrates a method for performing UWB communication by two UWB devices according to an embodiment of the present disclosure.

In the embodiment of FIG. 4, a first UWB device 400 may play a role as a controller (or controlee), and a second UWB device 410 may play a role as a controlee (or controller), which is the role opposite to the role of the first UWB device 400. The first UWB device 400 may play a role as an initiator (or responder), and the second UWB device 410 may play a role as a responder (or initiator), which is the role opposite to the role of the first UWB device 400.

(1) Referring to FIG. 4, the first UWB device 400 and the second UWB device 410 may optionally perform an OOB step before the UWB step (S401). In this disclosure, the OOB step may be referred to as an OOB connection step.

The OOB step may be a step performed to discover UWB devices through the OOB channel (e.g., BLE channel) and to establish and control a UWB session.

In an embodiment, the OOB step may include at least one of the following steps:
discovering UWB devices and profiles (device and profile discovery);
establishing an OOB connection (channel);
establishing a secure channel to secure messages and data; and
exchanging parameters for establishing a UWB session through the secure channel (e.g., UWB capability parameters (controlee capability parameters), UWB configuration parameters and/or session key-related parameters) (parameter exchange step).

In an embodiment, the parameter exchange step may include the step for the controlee to transfer controlee capability parameters/messages (UWB_CAPABILITY) to the controller, the step for the controller to transfer UWB configuration parameters/messages (UWB_CONFIGURATION) to the controlee, and/or the step for one UWB device to transfer session key-related parameters/messages (SESSION_KEY_INFO) for protecting the UWB session to the other UWB device.

In an embodiment, the controlee (UWB) capability parameter and/or session key parameter may be included and transmitted in the controlee information message (CONTROLLEE_INFO) which is the OOB message transferred from the controlee to the controller. In an embodiment, the UWB configuration parameter and/or session key parameter may be included and transmitted in the session data message (SESSION_DATA) which is the OOB message transferred from the controller to the controlee.

The controlee performance parameter (UWB_CAPABILITY) may include at least one parameter that provides information about the device capability of the controlee. For example, the controller performance parameter may include a parameter for supporting the role of the device (initiator or responder), a parameter for multi-node support, a parameter for supporting STS configuration, a parameter for supporting a ranging method, a RFRAME feature performance parameter, a parameter for supporting angle of arrival (AoA), and/or a parameter for supporting scheduled mode.

The UWB configuration parameter (UWB_CONFIGURATION) may include at least one parameter used for configuration of a UWB session. For example, UWB configuration parameters may include a UWB session ID parameter, a ranging method parameter, a multi-node configuration parameter, an STS configuration parameter, a scheduled mode parameter, a time-of-flight (ToF) report parameter, an AoA-related parameter, a parameter indicating the number of slots per ranging round, a slot duration parameter, a responder slot index parameter, a MAC address mode parameter, a device MAC address parameter, a parameter indicating the number of controlees, and/or a destination (DST) MAC address parameter.

The session key-related parameter (SESSION_KEY_INFO) may include a session key-related parameter for dynamic STS and/or a session key-related parameter for Static STS. For example, the session key-related parameter for dynamic STS may include data exchanged to generate a UWB session key or data directly used as a UWB session key. For example, the Static STS may include an ID (vendor ID) of a vendor that is a provider of the UWB-enabled application and any pre-defined value (static STS IV) selected by the UWB-enabled application for the UWB device. The vendor ID may be used to set the phy Vupper64 parameter for static STS, and the Static STS IV may be used to set the vUpper64 parameter.

(2) The first UWB device 400 and the second UWB device 410 may perform a UWB step (S403). In this disclosure, the UWB step may be referred to as an UWB connection step.

The UWB step may be a step which is performed to perform UWB ranging through the UWB session and transfer service data.

In an embodiment, the UWB step may include at least one of the following steps:
Starting a UWB session (UWB Trigger);
Performing UWB ranging to obtain the distance/position between two UWB devices; and
Exchanging service data (transaction).

As described above, the OOB step is an optional step and may be omitted in some embodiments. For example, when discovery of a UWB device and/or establishment and control of a UWB session are performed through a UWB channel (in-band), the OOB step may be omitted. For example, when in-band discovery is performed, the OOB step of performing OOB discovery may be omitted. In this case, the UWB step may further perform an operation for discovering a UWB device through the UWB channel and exchanging parameters for UWB session configuration.

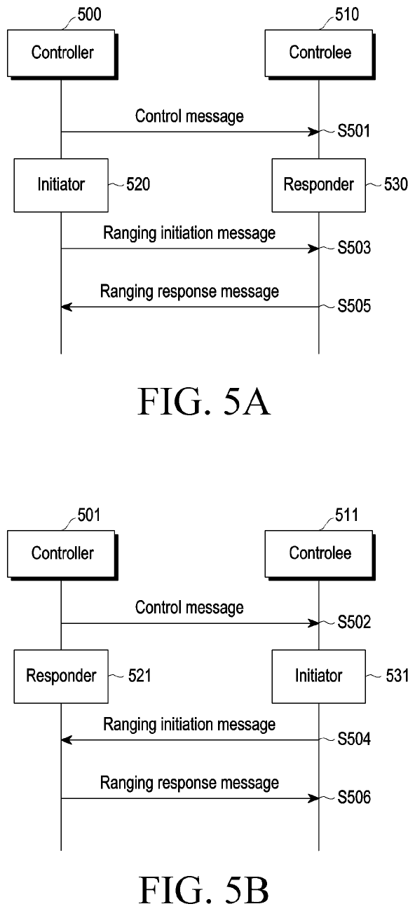

FIGS. 5A and 5B illustrate a method for performing UWB ranging by two UWB devices according to an embodiment of the present disclosure.

FIG. 5A illustrates an embodiment in which the first UWB device operates as the controller 500/initiator 520, and the second UWB device operates as the controlee 510/responder 530. FIG. 5B illustrates an embodiment in which the first UWB device operates as the controller 501/responder 521, and the second UWB device operates as the controlee 511/initiator 531.

Referring to FIGS. 5A and 5B, the controllers 500 and 501 may transmit a control message for UWB ranging to the controlee 510 and 511 (S501 and S502). The ranging control message may be used to carry ranging parameter(s) for controlling and configuring a ranging procedure. In an embodiment, the control message may include information about the role (e.g., initiator or responder) of the ranging device, ranging slot index information, and/or address information about the ranging device.

The initiators 520 and 531 may transmit a ranging initiation message for initiating UWB ranging to the responders 530 and 521 (S503 and S504). In an embodiment, the initiators 520 and 531 may transmit a ranging initiation message through an SP1 packet or an SP3 packet. When the ranging initiation message is transmitted through the SP1 packet, the control message may be included and transmitted in the PHY payload of the ranging initiation message. When the ranging initiation message is transmitted through the SP3 packet, the ranging initiation message does not include the PHR and PHY payloads.

The responders 530 and 521 may transmit a ranging response message to the initiators 520 and 531 in response to the ranging initiation message (S505 and S506). In an embodiment, the responders 530 and 521 may transmit a ranging response message through an SP1 packet or an SP3 packet. When the ranging reply message is transmitted through the SP1 packet, a first measurement report message may be included and transmitted in the PHY payload of the ranging reply message. In an embodiment, the first measurement report message may include an AoA measurement, a reply time measured by the responder and/or a list of round-trip time measurements for responders and responder addresses. The reply time field may indicate a time difference between the reception time of the ranging initiation message and the transmission time of the ranging reply message at the responder side. Based on this, single-sided two-way ranging (SS-TWR) may be performed. ToF calculation through SS-TWR follows the scheme defined in IEEE 802.15.4z or FiRa.

In the case of double-sided two-way ranging (DS-TWR), the initiators 520 and 531 may further transmit a ranging final message to the responders 530 and 521 to complete the ranging exchange. When the ranging final message is transmitted through the SP1 packet, a second measurement report message may be included and transmitted in the PHY payload of the ranging final message. In an embodiment, the second measurement report message may include an AoA measurement, the round-trip time for the first responder (first round-trip time) and/or a list of reply time measurements for responders and responder addresses. When the sender of the Measurement Report Message is the initiator, the First round-trip time field may indicate a time difference between the ranging initiation message from the initiator and the first ranging reply message from the first responder. Alternatively, when the sender of the Measurement Report Message is the responder, the First round-trip time field may indicate a time difference between the ranging reply message from the responder and the ranging final message from the initiator. Based on this, DS-TWR may be performed. Time-of-flight (ToF) calculation through DS-TWR follows the scheme defined in IEEE 802.15.4z or FiRa.

According to an embodiment, the above-described first measurement report message and/or second measurement report message may not be included in the ranging reply message and/or the ranging final message but may be transmitted as separate messages. For example, when the non-deferred mode is applied, the measurement report message may be transmitted through the data frame after the ranging exchange.

The initiators 520 and 531 and the responders 530 and 521 may perform UWB ranging according to a predetermined Schedule Mode. For example, in the time-scheduled ranging mode, the controller may know the IDs of all controlees and may designate an accurate schedule of ranging transmission. As another example, in the contention-based ranging mode, the controller does not know the number and ID of the controlees, and thus UWB devices compete with each other. In this case, a collision may occur between the responding devices.

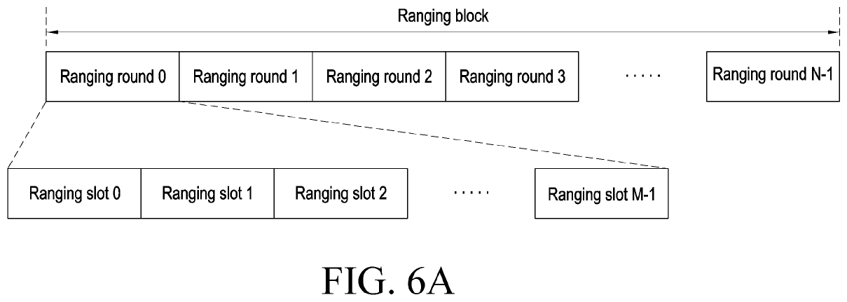

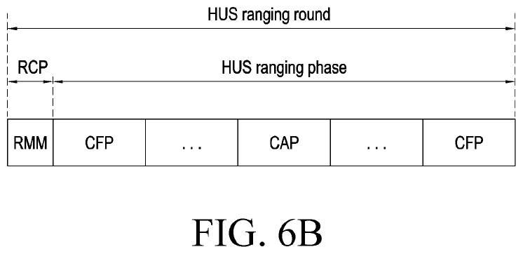

FIG. 6A illustrates a structure of a ranging block and a round used for UWB ranging according to an embodiment of the present disclosure.

In this disclosure, the ranging block refers to a time period for ranging. The ranging round may be a period of sufficient duration to complete one entire range-measurement cycle in which a set of UWB devices participating in a ranging exchange involves. The ranging slot may be a sufficient period for transmission of at least one ranging frame (RFRAME) (e.g., ranging initiation/reply/final message, etc.).

As shown in FIG. 6A, one ranging block may include at least one ranging round. Each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds. This may be configured through a control message from the controller.

FIG. 6B illustrates a structure of a ranging round used for hybrid ranging according to an embodiment of the present disclosure.

In the disclosure, the ranging round used for hybrid ranging may be referred to as a hybrid ranging round or a hyper UWB session ranging round (HUS ranging round). The scheduling mode in which hybrid ranging is used may be referred to as a hybrid-based mode. In the hybrid-based mode, the controller may perform ranging with the known controlee in the scheduling-based mode and with the unknown controlee in the contention-based mode.

Referring to FIG. 6B, in the hybrid-based mode, the ranging round may include a ranging control phase RCP and a ranging phase RP. The RP may include one or more contention free periods (CFPs) for scheduling-based ranging (access) and one or more contention access periods (CAPs) for contention-based ranging (access). The contention free period (CFP) may be scheduled based ranging and data transfer phase. Through hybrid ranging, the controller may drive scheduling-based ranging, contention-based ranging, and data transfer phase within one hybrid ranging round.

In the disclosure, the control message (ranging control message) used in the RCP of the hybrid-based mode may be referred to as a ranging management message (RMM). The ranging management message may be referred to as control message type 3 (CM type 3) or a third control message.

In the disclosure, each of the gate and the mobile device MD may be implemented as any one of the UWB device 10 of FIG. 1, the first UWB device 200 of FIG. 2, the second UWB device 210 of FIG. 2, the first UWB device 400 of FIG. 4, or the second UWB device 410 of FIG. 4.

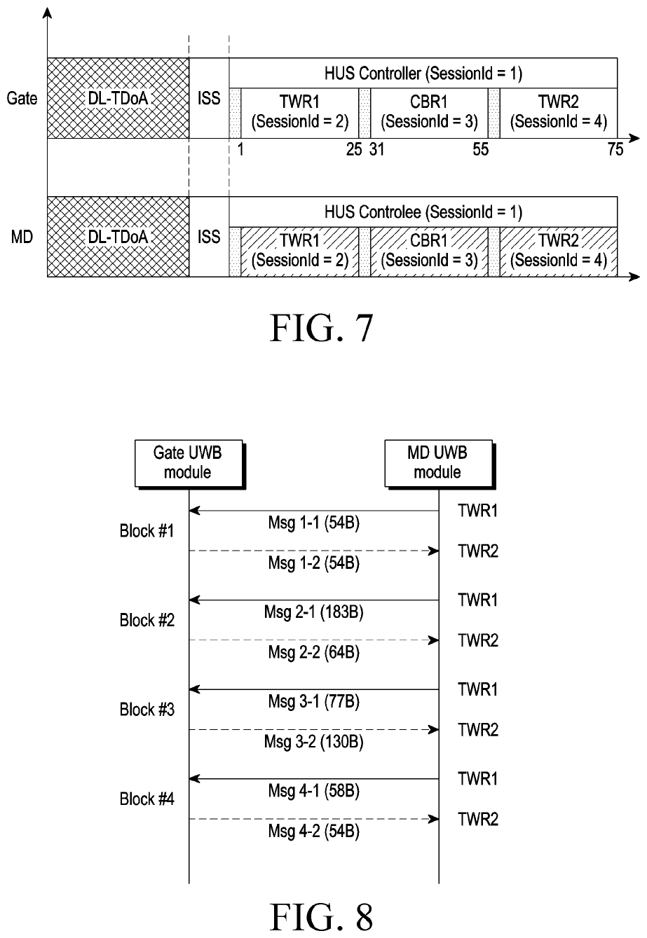

FIG. 7 illustrates an example of data exchange using hybrid UWB session (HUS) according to an embodiment of the disclosure.

In FIG. 7, the gate and the mobile device MD may perform a data exchange operation using a hybrid UWB session (HUS). When the data exchange protocol is operated using HUS, an ACK or retransmission mechanism may be performed so that the data exchange protocol may operate smoothly.

Referring to FIG. 7, a session (or a time period) and an inter-session space (ISS) period for downlink time-difference-of-arrival (DL-TDoA) between a gate and a mobile device MD may be set. In the set first session (e.g., SessionId=1), the gate may operate as a HUS controller, and the mobile device MD may operate as a HUS controlee. According to an embodiment, the first session (e.g., SessionId=1) may include a second session (e.g., SessionId=2) for first two-way ranging (TWR), a third session (e.g., SessionId=3) for a first contention-based ranging (CBR), and a fourth session (e.g., SessionId=4) for second TWR.

In the second session (e.g., SessionId=2), the gate and the mobile device MD may perform the TWR. In the third session (e.g., SessionId=3), each of the gate and the mobile device MD may perform a CBR. In the fourth session (e.g., SessionId=4), the gate and the mobile device MD may perform the TWR.

Meanwhile, there may be various phases where data transmission may occur in the HUS, and for this reason, it may be necessary to optimize when and in which phase the data transmission is to be performed. Further, the phase to be used may vary depending on the size of the data in the HUS.

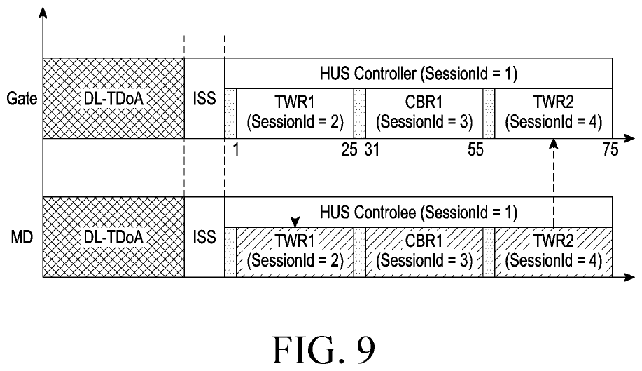

FIG. 8 illustrates an example of message exchange in a block according to an embodiment of the disclosure. FIG. 9 illustrates an example of data exchange using an HUS according to an embodiment of the disclosure.

Referring to FIG. 8, a message pair may be exchanged in one block of HUS. For example, two messages are one pair, and a total of four blocks should be repeated to complete the exchange of all of the message pairs.

In the first block #1, the UWB module of the mobile device MD may transmit a 1-1th message (e.g., 54 bytes) for the TWR to the UWB module of the gate, and the UWB module of the mobile device MD may receive a 1-2th message (e.g., 54 bytes) for the TWR from the UWB module of the gate.

In the second block #1, the UWB module of the mobile device MD may transmit a 2-1th message (e.g., 183 bytes) for the TWR to the UWB module of the gate, and the UWB module of the mobile device MD may receive a 2-2th message (e.g., 64 bytes) for the TWR from the UWB module of the gate.

In the third block #3, the UWB module of the mobile device MD may transmit a 3-1th message (e.g., 77 bytes) for the TWR to the UWB module of the gate, and the UWB module of the mobile device MD may receive a 3-2th message (e.g., 130 bytes) for the TWR from the UWB module of the gate.

In the fourth block #4, the UWB module of the mobile device MD may transmit a 4-1th message (e.g., 58 bytes) for the TWR to the UWB module of the gate, and the UWB module of the mobile device MD may receive a 4-2th message (e.g., 58 bytes) for the TWR from the UWB module of the gate.

Referring to FIGS. 8 and 9, in the second session (e.g., SessionId=2), the gate may transmit a first message of the TWR to the mobile device MD, and in the fourth session (e.g., SessionId=4), the mobile device MD may transmit a second message for the TWR to the gate.

When one message pair is exchanged in one block of HUS, and when message size or segmentation is not taken into account, a total of four blocks should be repeated to complete the exchange of all of the message pairs. In this case, without considering packet loss or ACK, the gate and the mobile device MD may operate with a message where a response is transmitted considered as an ACK.

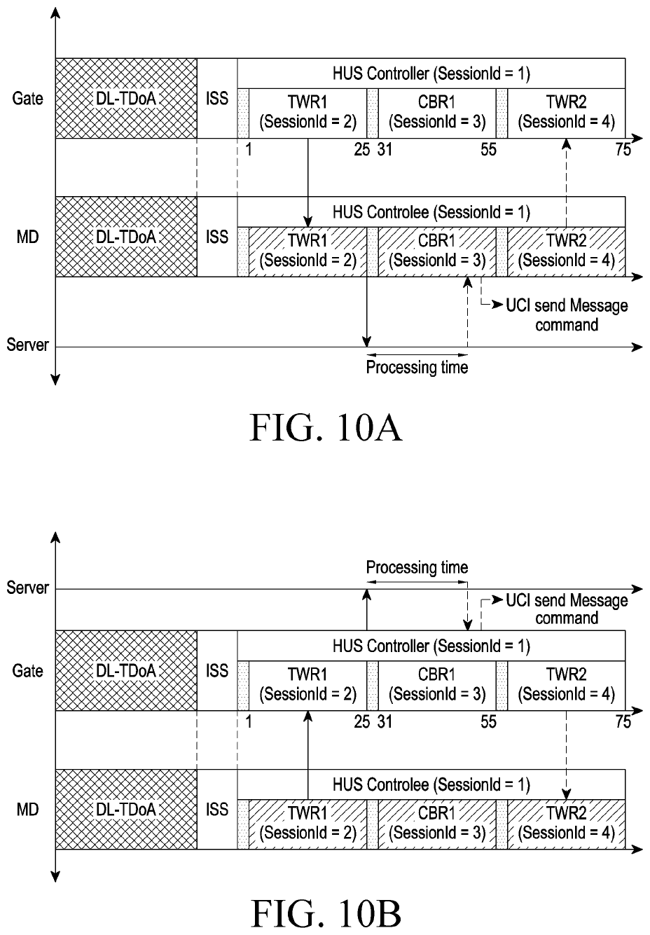

FIGS. 10A and 10B illustrate an example of adjusting a length of a CBR phase considering a processing time according to an embodiment of the disclosure.

Referring to FIG. 10A, a processing delay between a UWB device (gate and/or mobile device MD) and a server may occur, and CBR duration (or length of CBR phase) may be adaptively determined according to a processing delay between message pair exchanges.

Referring to FIGS. 10A and 10B, a session (or a time period) and an ISS period for DL-TDoA between the gate and the mobile device MD may be set. In the set first session (e.g., SessionId=1), the gate may operate as a HUS controller, and the mobile device MD may operate as a HUS controlee. According to an embodiment, the first session (e.g., SessionId=1) may include a second session (e.g., SessionId=2) for first TWR, a third session (e.g., SessionId=3) for a first CBR, and a fourth session (e.g., SessionId=4) for second TWR.

<FIG. 10a: a Case in which a Processing Time Occurs Between the Mobile Device MD and the Server>

Referring to FIG. 10A, in the second session (e.g., SessionId=2), the gate may transmit a first message for the TWR to the mobile device MD. In the second session (e.g., SessionId=2), the mobile device MD may transmit the first message for the TWR to the server. The server receiving the first message for the TWR may transmit a response message to the first message for the TWR to the mobile device MD after a processing time. The processor in the mobile device MD may transfer a UWB command interface (UCI) command (UCI) (UCI sendMessage command) for transmitting the second message for the TWR corresponding to the response message to the UWBS in the mobile device MD. In the fourth session (e.g., SessionId=4), the mobile device MD may transmit the second message for the TWR to the gate.

According to an embodiment, the length of the CBR phase of the third session (e.g., SessionId=3) may be adaptively adjusted based on a processing time between the mobile device MD and the server.

<FIG. 10B: a Case in which a Processing Time Occurs Between the Gate and the Server>

Referring to FIG. 10B, in the second session (e.g., SessionId=2), the mobile device MD may transmit the first message for the TWR to the gate. In the second session (e.g., SessionId=2), the gate may transmit the first message for the TWR to the server. The server receiving the first message for the TWR may transmit a response message to the first message for the TWR to the gate after a processing time. The processor in the gate may transfer a UCI command (UCI) (UCI sendMessage command) for transmitting the second message for the TWR corresponding to the response message to the UWBS in the gate. In the fourth session (e.g., SessionId=4), the gate may transmit the second message for the TWR to the mobile device MD.

According to an embodiment, the length of the CBR phase of the third session (e.g., SessionId=3) may be adaptively adjusted based on a processing time between the gate and the server.

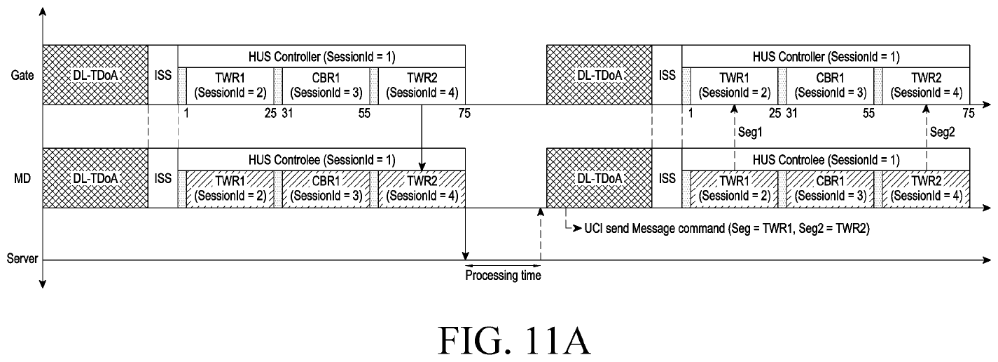

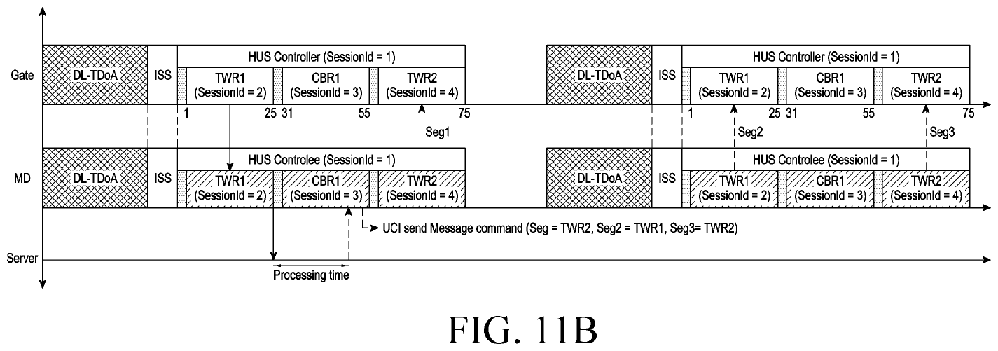

FIGS. 11A and 11B illustrate an example oof segmentation according to a message length according to an embodiment of the disclosure.

According to an embodiment, a phase for performing message transmission (sendMessage) may be optimized and set through segmentation according to the message length. According to an embodiment, phase selection according to the number of segmentations may be performed based on the timing of message transmitted from the server.

FIG. 11A illustrates an example operation when there are two segmentations, and FIG. 11B illustrates an example operation when there are three or more segmentations.

Referring to FIG. 11A, in the fourth session (e.g., SessionId=4) in the first HUS ranging round, the gate may transmit the first message for the TWR to the mobile device MD. In the fourth session (e.g., SessionId=4) in the first HUS ranging round, the mobile device MD may transmit the first message for the TWR to the server. The server receiving the first message for the TWR may transmit a response message to the first message for the TWR to the mobile device MD after the processing time.

The processor in the mobile device MD may transmit a UCI command (UCI sendMessage command (seg1=TWR1, seg2=TWR2), which segments the second message for the TWR corresponding to the response message into two pieces and transmits the same, to the UWBS in the mobile device MD. The second message for the TWR may be segmented into a 2-1th message Seg1 and a 2-2th message Seg2.

In the second session (e.g., SessionId=2) in the second HUS ranging round, the mobile device MD may transmit the 2-1th message Seg1 for the TWR to the gate. In the fourth session (e.g., SessionId=4) in the second HUS ranging round, the mobile device MD may transmit the 2-2th message Seg2 for the TWR to the gate. According to an embodiment, the second HUS ranging round may be the very next ranging round to the first HUS ranging round.

Referring to FIG. 11B, in the second session (e.g., SessionId=2) in the first HUS ranging round, the gate may transmit the first message for the TWR to the mobile device MD. In the second session (e.g., SessionId=2), the mobile device MD may transmit the first message for the TWR to the server. The server receiving the first message for the TWR may transmit a response message to the first message for the TWR to the mobile device MD after the processing time.

The processor in the mobile device MD may transmit a UCI command (UCI sendMessage command (seg1=TWR1, seg2=TWR2, seg3=TWR2), which segments the second message for the TWR corresponding to the response message into three pieces and transmits the same, to the UWBS in the mobile device MD. The second message for the TWR may be segmented into a 2-1th message Seg1, a 2-2th message Seg2, and a 2-3 message Seg3.

In a fourth session (e.g., SessionId=4) in the first HUS ranging round, the mobile device MD may transmit the 2-1th message Seg1 for the TWR to the gate.

In the second session (e.g., SessionId=2) in the second HUS ranging round, the mobile device MD may transmit the 2-2th message Seg2 for the TWR to the gate. In the fourth session (e.g., SessionId=4) in the second HUS ranging round, the mobile device MD may transmit the 2-3 message Seg3 for the TWR to the gate. According to an embodiment, the second HUS ranging round may be the very next ranging round to the first HUS ranging round.

For convenience of description, although FIG. 11A illustrates a case where there are two segmentations, and FIG. 11B illustrates a case where there are three segmentations, the technical spirit of the disclosure may be applied to all cases where the message is segmented in various numbers of pieces.

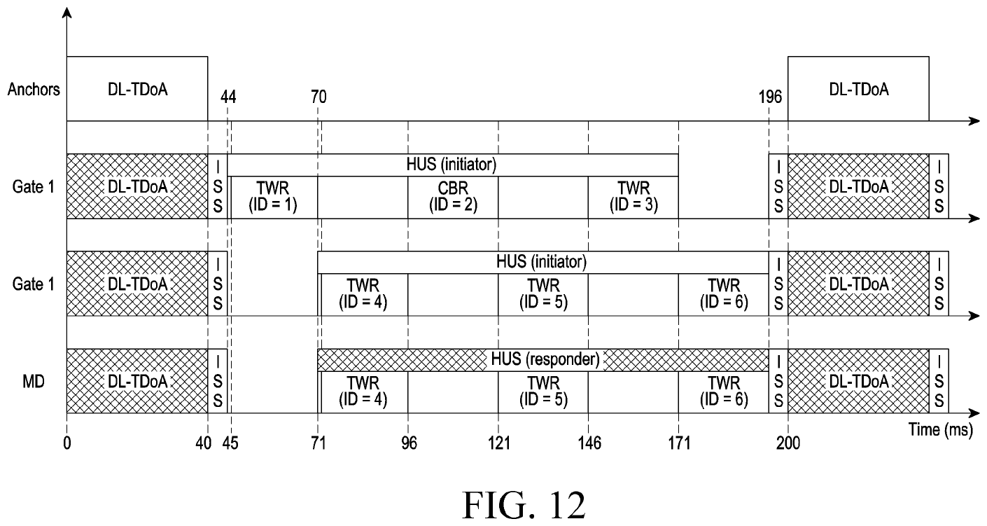

FIG. 12 illustrates an example of configuring a TWR phase in a multi-gate multi-user circumstance according to an embodiment of the disclosure.

A gate phase configuration may be set in a single-channel multi-path scenario. According to an embodiment, the gap between TWR phases in the HUS may be maintained as far as possible. According to an embodiment, the gap between the CBR phases between the two gates may also be maintained as far as possible so that the mobile device easily discovers the gate. According to an embodiment, when a phase is configured in an interleaving manner, an interphase space (overhead) may be minimized.

Referring to FIG. 12, a time period for DL-TDoA and a time period for ISS may be set in anchors, a first gate, a second gate, and a mobile device MD. The first gate (e.g., Gate 1) may operate as an initiator in a plurality of sessions (e.g., session ID=1, 2, and 3) in the HUS. The second gate (e.g., Gate 2) may operate as an initiator in a plurality of sessions (e.g., session ID=4, 5, and 6) in the HUS. The mobile device MD may operate as a responder in a plurality of sessions (e.g., session ID=4, 5, and 6) in the HUS. In some sessions (e.g., session ID=4 and 6) in the HUS, the mobile device MD may exchange messages for the TWR with the second gate (e.g., Gate 2).

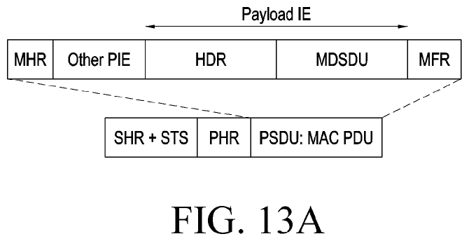

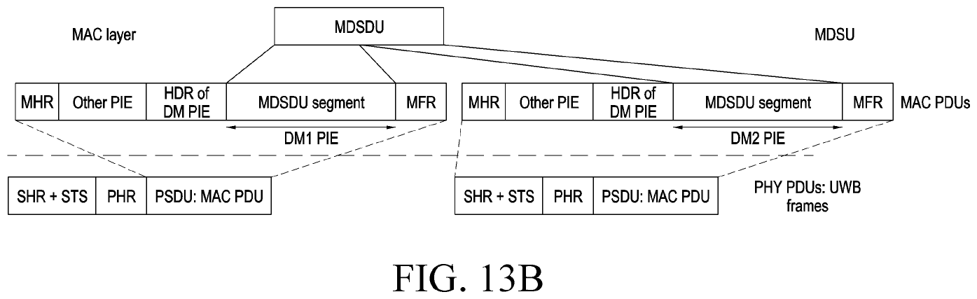

FIGS. 13A and 13B illustrate examples of data segmentation according to an embodiment of the disclosure.

Referring to FIG. 13A, a MAC SDU may include a MAC header (MHR), other PIE (Payload IE), the payload IE's HDR (header), the payload IE's MAC data service data unit (MDSDU), and a MAC footer (MFR). The PHY PDU may include a synchronization header (SHR)+STS, a PHR (PHY header), and a PSDU (PHY payload), and the PSDU may include a MAC SDU. The PHY PDU may constitute a UWB frame.

Referring to FIG. 13B, the MDDU of the MAC layer may be segmented into a MDDU segment DM1 PIE and a MDDU segment DM2 PIE. The MDSDU segment DM1 PIE may be included and transmitted in the PSDU in the first PHY PDU (or the first UWB frame), and the MDSDU segment DM2 PIE may be included and transmitted in the PSDU in the second PHY PDU (or the second UWB frame). In this case, the DMPIE may be a data message (DM) payload IE.

According to an embodiment, a first device transmitter transmitting a message may specify that the message is a segmented message and transmit the same. The second device receiver receiving the message may listen to all segmented messages and then transmit a status message including a reception result to the first device transmitter. The first device transmitter may retransmit a segment requiring retransmission to the second device receiver according to the reception status.

The disclosure defines a message transmission format and a status format when segmenting, criteria for segmenting a message, a method for setting a segmented message length, and a segmented message transmission method.

According to an embodiment, the segment message transmission format may be configured as shown in Table 1.

TABLE 1

| | | Size | |
|---|---|---|---|
| | Parameter | (bits) | Note |
| HDR | Vendor OUI | 24 | 0x5A18FF |
| | UWB Message ID | 4 | 0x8: Data Message |
| | DM Type | 4 | 0x2: Segmented Payload |
| Content | Payload Size | 16 | Size(N) of Payload field |
| | Segment Index | 8 | current index |
| | Payload | (N − 1)*8 | MDSDU |

Referring to Table 1, for the segment message, the DM type parameter may be set to a defined value (e.g., 0x2: segmented payload). The segment index parameter may be configured in a set size (e.g., 8 bits) and indicate the index of the segment message, and the payload parameter may be configured in a size (e.g., (N-1)*8 bits) set based on the segment index parameter.

According to an embodiment, the status message format may be configured as shown in Table 2.

TABLE 2

| | | Size | |
|---|---|---|---|
| | Parameter | (bits) | Note |
| HDR | Vendor OUI | 24 | 0x5A18FF |
| | UWB Message ID | 4 | 0x8: Data Message |
| | DM Type | 4 | 0x3: Status Payload |
| Content | Payload Size | 16 | Size(N) of Payload field |
| | Payload | N*8 | MDSDU |

Referring to Table 2, the DM type may be newly defined in the header (HDR) to specify that the payload is status. According to an embodiment, the payload message may be configured of {Segment Index, Success (1) or failed (0)}. The payload message may indicate the index of the segment message and indicate whether the corresponding segment message is successfully received.

For example, when the data is composed of 123456789, and the data is segmented into three messages, the segment message is set as shown in Table 3, and the status message may be configured as shown in Table 4.

TABLE 3

| | Segmented | Segmented | Segmented |
|---|---|---|---|
| Parameter | msg 1 | msg 2 | msg 3 |
| Segment Index | 1 | 2 | 3 |
| Payload | 123 | 456 | 789 |

TABLE 4

| Parameter | Status message |
|---|---|
| Payload | 1 0 2 1 3 1 |

Referring to Table 3, the segment index of the first segmented message segmented msg 1 is set to 1, and the payload of the first segmented message segmented msg 1 may include 123. The segment index of the second segmented msg 2 may be set to 2, and the payload of the second segmented msg 2 may include 456. The segment index of the third segmented msg 3 may be set to 3, and the payload of the third segmented msg 3 may include 789.

Referring to Table 3 and Table 4, the payload of the status message may include 102 1 3 1, which may indicate that the first segmented message segmented msg 1 is not received; the second segmented message segmented msg 2 is received successfully; and the third segmented message segmented msg 1 is received successfully.

Tables 3 and 4 show examples of segment messages and status messages for convenience of description, and the segment messages and status messages may be variously configured according to the technical spirit of the disclosure.

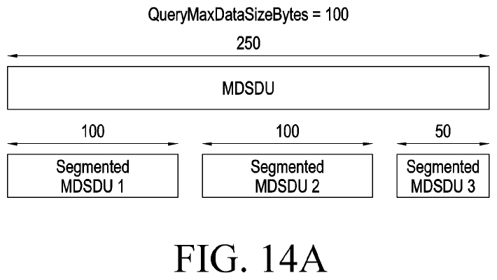

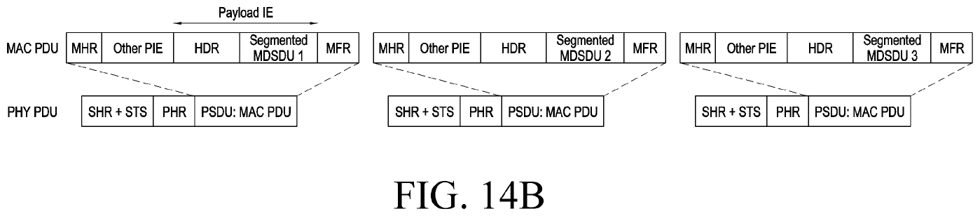

FIGS. 14A and 14B illustrate examples of data segmentation according to an embodiment of the disclosure.

When the size of the data exceeds the data size queryMaxDataSizeBytes that the phase may accommodate, a criterion for segmenting the message may be determined. According to an embodiment, data may be segmented for each data size queryMaxDataSizeBytes in which the corresponding phase may accommodate.

Referring to FIG. 14A, when the data size queryMaxDataSizeBytes that the phase may accommodate is 100 bytes and the MDDU is 250 bytes, the MDDU may be segmented into three pieces. For example, the first segmented MDSDU segmented MDSDU 1 may be composed of 100 bytes, the second segmented MDSDU segmented MDSDU 2 may be composed of 100 bytes, and the third segmented MDSDU segmented MDSDU 3 may be composed of 50 bytes.

Referring to FIGS. 14A and 14B, the payload IE of the first MAC PDU may include the first segmented MDSDU segmented MDSDU 1, the payload IE of the second MAC PDU may include the second segmented MDSDU segmented MDSDU 2, and the payload IE of the third MAC PDU may include the third segmented MDSDU segmented MDSDU 3.

The first segmented MDSDU segmented MDSDU 1 may be included and transmitted in the PSDU in the first PHY PDU (or the first UWB frame), the second segmented MDSDU segmented MDSDU 2 may be included and transmitted in the PSDU in the second PHY PDU (or the second UWB frame), and the third segmented MDSDU segmented MDSDU 3 may be included and transmitted in the PSDU in the third PHY PDU (or the third UWB frame).

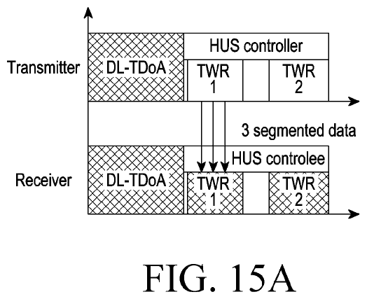

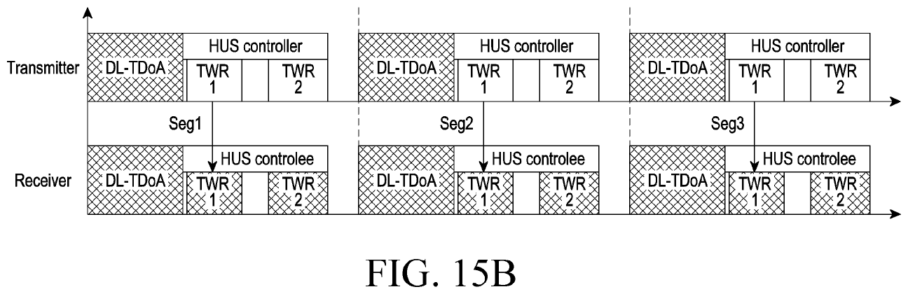

FIGS. 15A and 15B illustrate examples of transmitting a segmented message according to an embodiment of the disclosure.

Referring to FIG. 15A, the segmented message may be transmitted multiple times in a single phase. The first device transmitter, which is a controller in the HUS, may transmit a plurality of (e.g., three) segmented data to the second device receiver, which is a controlee in the HUS, in the first time period (or first session) for the TWR.

Referring to FIG. 15B, one segmented message may be transmitted in one phase over several periods. The first device transmitter, which is a controller in the HUS, may transmit the first segmented data segmented data 1 to the second device receiver, which is a controlee in the HUS, in the first time period (or first session) for the TWR. Thereafter, the first device transmitter may transmit the second segmented data segmented data 2 to the second device receiver in the first time interval (or first session) for the TWR of the next period. Thereafter, the first device transmitter may transmit the third segmented data segmented data 3 to the second device receiver in the first time interval (or first session) for the TWR of the next period.

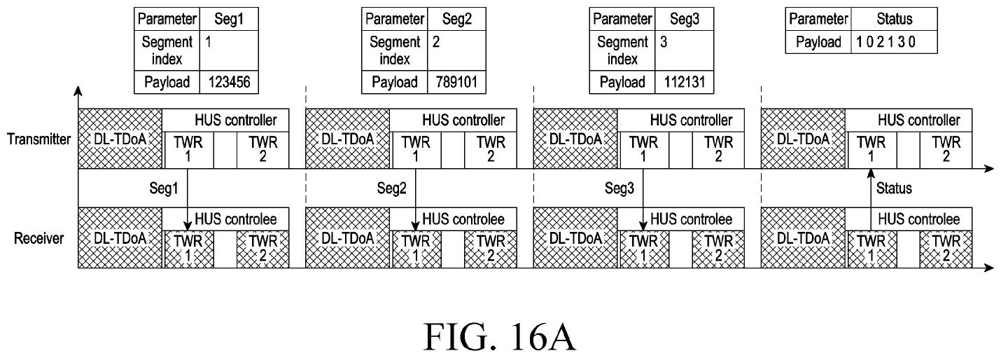

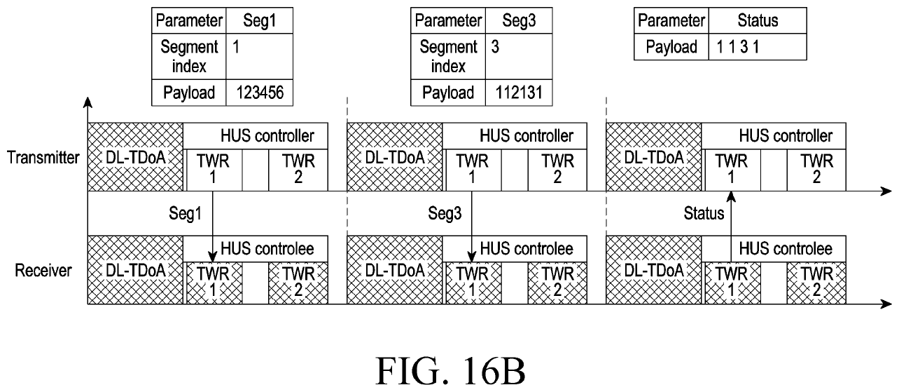

FIGS. 16A and 16B illustrate examples of transmitting a segmented message according to an embodiment of the disclosure.

Referring to FIGS. 16A and 16B, e.g., data may be composed of 123456789101112131, the data may be segmented into three messages, and the data size of queryMaxDataSizeBytes may be set to 6.

Referring to FIG. 16A, the segment index of the first segmented message Seg1 may be set to 1, and the payload of the first segmented message Seg1 may include 123456. The segment index of the second segmented message Seg2 may be set to 2, and the payload of the second segmented message Seg2 may include 789101. The segment index of the third segmented message Seg3 may be set to 3, and the payload of the third segmented message Seg3 may include 112131.

The first device transmitter, which is a controller in the HUS, may transmit the first segmented message Seg1 to the second device receiver, which is a controlee in the HUS, in the first time period (or first session) for the TWR. Thereafter, the first device transmitter may transmit the second segmented message Seg2 to the second device receiver in the first time period (or the first session) for the TWR of the next period. Thereafter, the first device transmitter may transmit the third segmented message Seg3 to the second device receiver in the first time period (or the first session) for the TWR of the next period.

Thereafter, the second device receiver may transmit the status message (e.g., Status) to the first device transmitter in the first time period (or the first session) for the TWR of the next period. For example, the payload of the status message may include 1 0 2 1 3 0. The status message may indicate that the first segmented message Seg1 is not received; the second segmented message Seg2 is successfully received; and the third segmented message Seg3 is not received.

Referring to FIGS. 16A and 16B, the first device transmitter receiving the status message may determine to retransmit the first segmented message Seg1 and the third segmented message Seg3.

Referring to FIG. 16B, the first device transmitter may retransmit the first segmented message Seg1 to the second device receiver that is a controlee in the HUS in the first time period (or first session) for the TWR. Thereafter, the first device transmitter may retransmit the third segmented message Seg3 to the second device receiver in the first time period (or the first session) for the TWR of the next period.

Thereafter, the second device receiver may transmit the status message to the first device transmitter in the first time period (or the first session) for the TWR of the next period. For example, the payload of the status message may include 1 1 3 1. The status message may indicate that the first segmented message Seg1 is successfully received; the third segmented message Seg3 is successfully received.

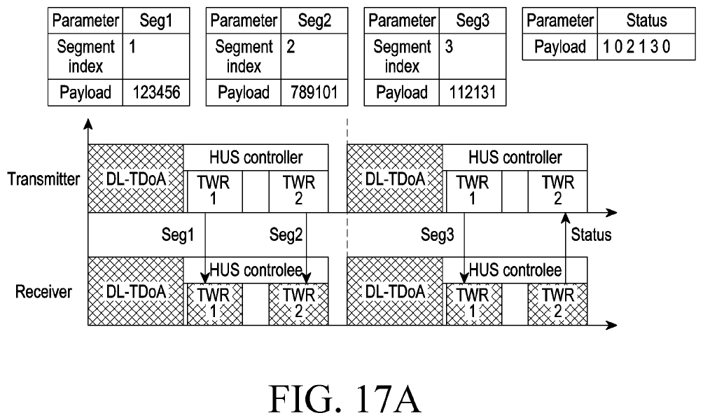

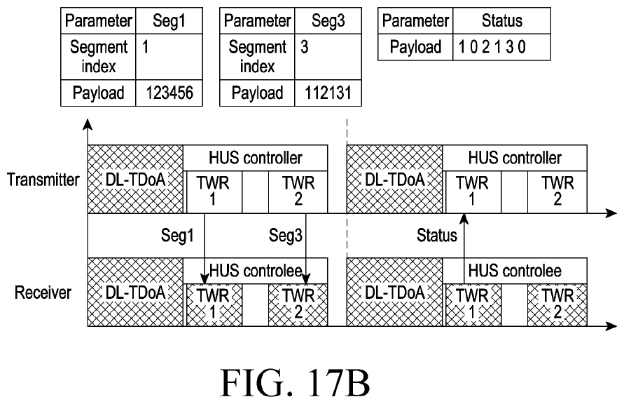

FIGS. 17A and 17B illustrate examples of transmitting a segmented message according to an embodiment of the disclosure.

Referring to FIGS. 17A and 17B, e.g., data may be composed of 123456789101112131, the data may be segmented into three messages, and the data size of queryMaxDataSizeBytes may be set to 6.

Referring to FIG. 17A, the segment index of the first segmented message Seg1 may be set to 1, and the payload of the first segmented message Seg1 may include 123456. The segment index of the second segmented message Seg2 may be set to 2, and the payload of the second segmented message Seg2 may include 789101. The segment index of the third segmented message Seg3 may be set to 3, and the payload of the third segmented message Seg3 may include 112131.

The first device transmitter, which is a controller in the HUS, may transmit the first segmented message Seg1 to the second device receiver, which is a controlee in the HUS, in the first time period (or first session) for the TWR. Thereafter, the first device transmitter may transmit the second segmented message Seg2 to the second device receiver in the second time period (or the second session) for the TWR. Thereafter, the first device transmitter may transmit the third segmented message Seg3 to the second device receiver in the first time period (or the first session) for the TWR of the next period.

Thereafter, the second device receiver may transmit the status message to the first device transmitter in the second time period (or the second session) for the TWR of the next period. For example, the payload of the status message may include 1 0 2 1 3 0. The status message may indicate that the first segmented message Seg1 is not received; the second segmented message Seg2 is successfully received; and the third segmented message Seg3 is not received.

Referring to FIGS. 17A and 17B, the first device transmitter receiving the status message may determine to retransmit the first segmented message Seg1 and the third segmented message Seg3.

Referring to FIG. 17B, the first device transmitter may retransmit the first segmented message Seg1 to the second device receiver that is a controlee in the HUS in the first time period (or first session) for the TWR. Thereafter, the first device transmitter may retransmit the third segmented message Seg3 to the second device receiver in the second time period (or the second session) for the TWR.

Thereafter, the second device receiver may transmit the status message to the first device transmitter in the first time period (or the first session) for the TWR of the next period. For example, the payload of the status message (e.g., Status) may include 1 1 3 1. The status message may indicate that the first segmented message Seg1 is successfully received; the third segmented message Seg3 is successfully received.

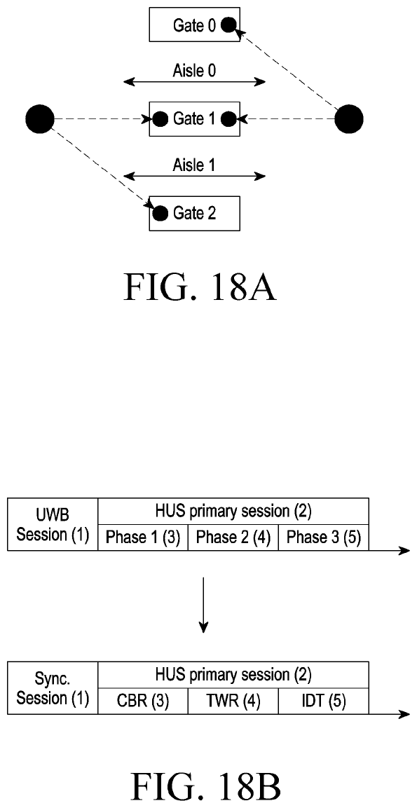

FIGS. 18A and 18B illustrate an example of performing UWB communication through a multi-channel according to an embodiment of the disclosure.

In order to realize a UWB contactless gate (UCG) in multi-aisle and two-way traffic environments, the need for multi-channel operation is emerging. Currently, it is possible to generate up to five UWBS sessions and, in the case of HUS, generate three phases based on the current UCG hardware specifications. According to an embodiment, it is possible to configure one HUS session (having three phases) and one UWB session while meeting the UCG hardware specifications. For each gate, at least one operation among device discovery, grasping of mutual distance, and transmission of payment data may be performed, and a phase for CBR, TWR, and in-band data transmission (IDT) may be performed when configuring the HUS phrase.

Referring to FIG. 18A, Aisle #0 may be set between Gate #0 and Gate #1, and Aisle #1 may be set between Gate #1 and Gate #2. For example, the mobile device MD may perform UWB communication with each of the UWB module of Gate #0 and the UWB module of Gate #1 to perform at least one operation among device discovery, grasping of mutual distance, and payment data transmission around Aisle #0. The mobile device MD may perform UWB communication with each of the UWB module of Gate #1 and the UWB module of Gate #2 to perform at least one operation among device discovery, grasping of mutual distance, and payment data transmission around Aisle #1.

Referring to FIG. 18B, one UWB session and one HUS primary session may be configured. One HUS primary session may include three phases. For example, session ID=1 may be set to the UWB session, session ID=2 may be set to the HUS primary session, and session ID=3, 4, and 5 may be set to the three phases, respectively, included in the HUS primary session. For example, the UWB session may be set as a synchronization session, the first phase in the HUS primary session may be set as an interval for CBR, the second phase in the HUS primary session may be set as an interval for the TWR, and the third phase in the HUS primary session may be set as an interval for IDT.

Meanwhile, in the case of two-way traffic, two UWB modules may be provided even for a single path, and it may be performed to add phrase in proportion to the number of the UWB modules of the gate. For example, the number of HUS phases (#of HUS phases) may be implemented as 3 phases*#of UWB module.

In a two-aisle two-way traffic environment, one UWB module may be controller and generate one primary UWB session. Since four UWB modules included in the gates are provided in FIG. 18A, at least 12 phases may be provided to be generated. For example, at least 13 UWBS sessions may be provided and, considering the synchronization session, 14 sessions may be provided to be generated.

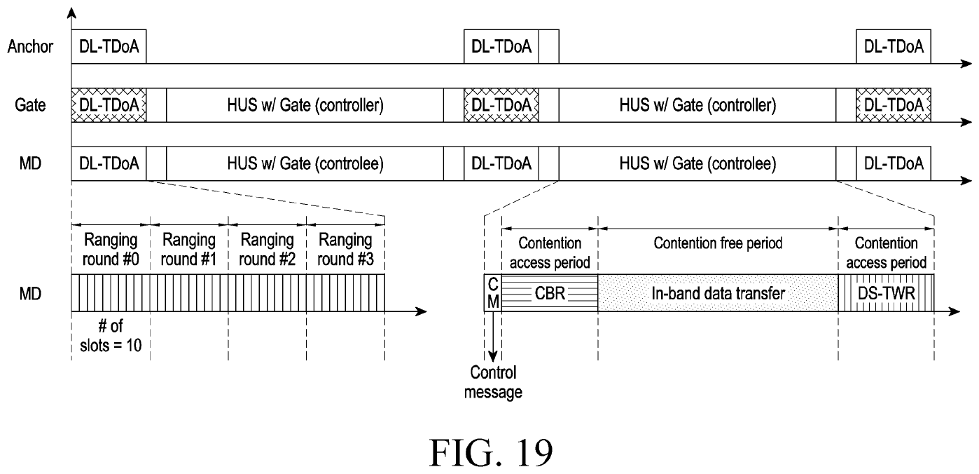

FIG. 19 illustrates an example of a synchronization session for an HUS operation according to an embodiment of the disclosure.

Referring to FIG. 19, a time period for DL-TDoA may be set in anchors Anchor, gate, and mobile device MD. According to an embodiment, the time period for the DL-TDoA may be set as a synchronization session for an HUS operation. For example, the time period for DL-TDoA may include four ranging rounds #0 to #3. Each of the four ranging rounds #0 to #3 may include 10 ranging slots.

A time period for HUS may be set in the gate and the mobile device MD. The gate may operate as a controller of the HUS, and the mobile device MD may operate as a controlee of the HUS. According to an embodiment, the time period for the HUS may include a period for transmitting a control message, a content access period (CAP) for CBR, a content free period (CFP) for IDT, and a CAP for DS-TWR.

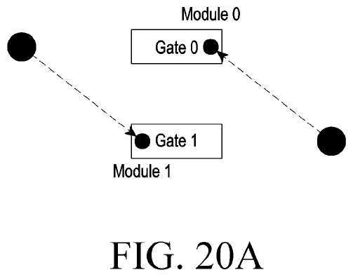

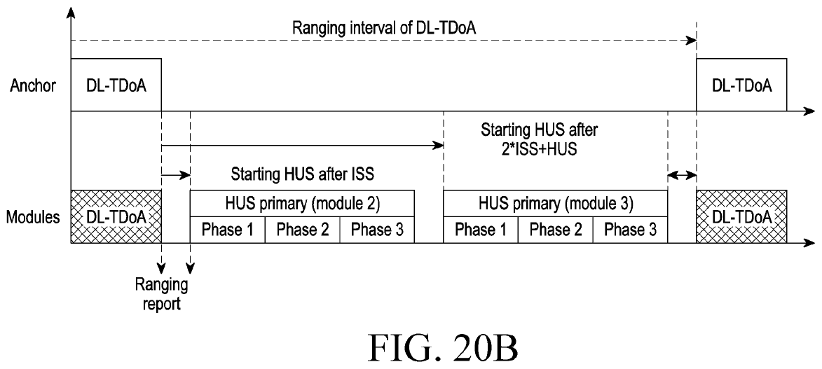

FIGS. 20A and 20B illustrate an example of performing UWB communication in a single-aisle scenario according to an embodiment of the disclosure.

Referring to FIG. 20A, a single-aisle may be set between Gate #0 and Gate #1. For example, the mobile device MD may perform UWB communication with each of the UWB module Module 0 of Gate #0 and the UWB module Module 1 of Gate #1 to perform at least one operation among device discovery, grasping of mutual distance, and payment data transmission around the single-aisle.

Referring to FIG. 20B, a time period for DL-TDoA may be set in each of the UWB modules of the anchor and the gate. In an embodiment, operations for synchronization may be performed in the time period for DL-TDoA. According to an embodiment, a ranging interval for the time period for DL-TDoA may be set.

The HUS primary for the UWB module Module 0 of Gate #0 may start, the ISS after the time period for DL-TDoA. The HUS for the UWB module Module 0 may include three phases.

The HUS primary for the UWB module Module 1 of Gate #1 may start, 2*ISS+HUS after the time period for DL-TDoA. The HUS for the UWB module Module 1 of Gate #1 may include three phases.

According to an embodiment, an operation for synchronization of DL-TDoA anchors may be performed on a multi-channel. The multi-channel operation of DL-TDoA may be possible. According to an embodiment, an initial message, a final message, and/or a ranging report of an nth ranging round of the time period of DL-TDoA may be transmitted/received. According to an embodiment, HUS may be operated based on DL-TDoA sessions.

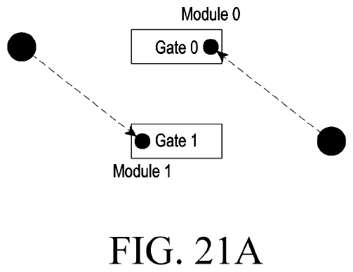

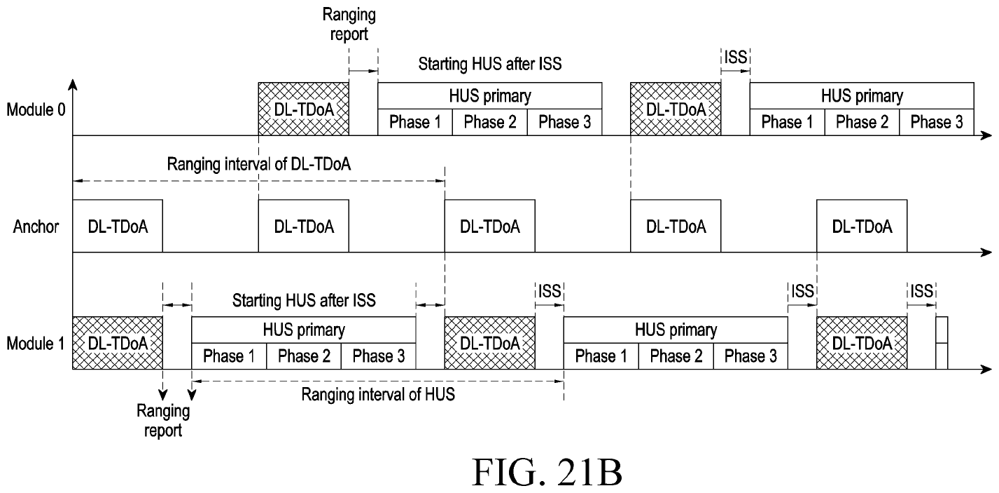

FIGS. 21A and 21B illustrate an example of performing UWB communication in a single-aisle scenario according to an embodiment of the disclosure.

Referring to FIG. 21A, a single-aisle may be set between Gate #0 and Gate #1. For example, the mobile device MD may perform UWB communication with each of the UWB module Module 0 of Gate #0 and the UWB module Module 1 of Gate #1 to perform at least one operation among device discovery, grasping of mutual distance, and payment data transmission around the single-aisle.

Referring to FIG. 21B, a DL-TDoA period for synchronization between the UWB module Module 0 of Gate #0 and the anchor may be set on a first channel (e.g., channel 5). The HUS primary for the UWB module Module 0 of Gate #0 may start, the ISS after the DL-TDoA period. The HUS for the UWB module Module 0 may include three phases.

A DL-TDoA period for synchronization between the UWB module Module 1 of Gate #1 and the anchor may be set on a second channel (e.g., channel 9). The HUS primary for the UWB module Module 0 of Gate #0 may start, the ISS after the DL-TDoA period. The HUS for the UWB module Module 0 may include three phases.

The anchor may perform DL-TDoA using a different frequency channel from each of the UWB module Module 0 of Gate #0 and UWB module Module 1 of Gate #1. According to an embodiment, operations for synchronization may be performed in each DL-TDoA period. According to an embodiment, a ranging interval for each DL-TDoA period may be set. According to an embodiment, if a higher ranging frequency is set, a shorter transaction latency may occur.

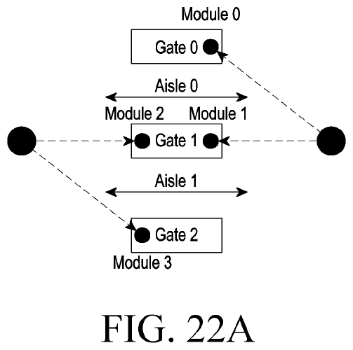

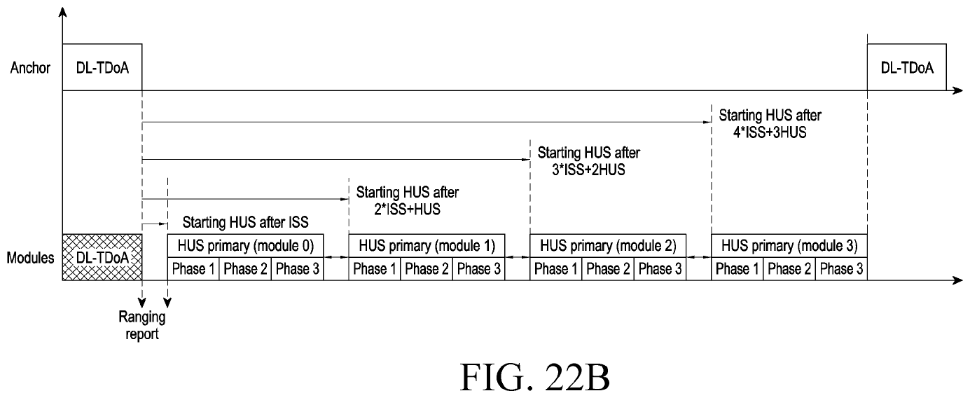

FIGS. 22A and 22B illustrate an example of performing UWB communication in a multi-aisle scenario according to an embodiment of the disclosure.

Referring to FIG. 22A, Aisle #0 may be set between Gate #0 and Gate #1, and Aisle #1 may be set between Gate #1 and Gate #2. For example, the mobile device MD may perform UWB communication with each of the UWB module Module 0 of Gate #0 and the UWB module Module 1 of Gate #1 to perform at least one operation among device discovery, grasping of mutual distance, and payment data transmission around Aisle #0. The mobile device MD may perform UWB communication with each of the UWB module Module 2 of Gate #1 and the UWB module Module 3 of Gate #2 to perform at least one operation among device discovery, grasping of mutual distance, and payment data transmission around Aisle #1.

Referring to FIG. 22B, a time period for DL-TDoA may be set in each of the UWB modules of the anchor and the gate. In an embodiment, operations for synchronization may be performed in the time period for DL-TDoA. According to an embodiment, a ranging interval for the time period for DL-TDoA may be set.

The HUS primary for the UWB module Module 0 of Gate #0 may start, the ISS after the time period for DL-TDoA. The HUS for the UWB module Module 0 of Gate #0 may include three phases.

The HUS primary for the UWB module Module 0 of Gate #1 may start, 2*ISS+HUS after the time period for DL-TDoA. The HUS for the UWB module Module 0 of Gate #1 may include three phases.

The HUS primary for the UWB module Module 2 of Gate #1 may start, 3*ISS+2HUS after the time period for DL-TDoA. The HUS for the UWB module Module 2 of Gate #1 may include three phases.

The HUS primary for the UWB module Module 3 of Gate #1 may start, 4*ISS+3HUS after the time period for DL-TDoA. The HUS for the UWB module Module 3 of Gate #1 may include three phases.

An operation for synchronization of DL-TDoA anchors may be performed on a multi-channel. The multi-channel operation of DL-TDoA may be possible. According to an embodiment, an initial message, a final message, and/or a ranging report of an nth ranging round of the time period of DL-TDoA may be transmitted/received. According to an embodiment, HUS may be operated based on DL-TDoA sessions.

For example, for serial operations of a plurality of UWB modules in UCG, the DL-TDoA duration may be set to a first time (e.g., 40 ms), the ISS may be set to a second time (e.g., 10 ms), the duration of each Phase may be set to a third time (e.g., 30 ms), and the ranging interval of each HUS session and DL-TDoA may be set to a fourth time (e.g., 440 ms). In this case, 4*ISS+4*3*Phase=400 ms.

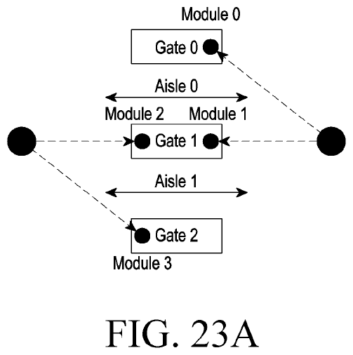

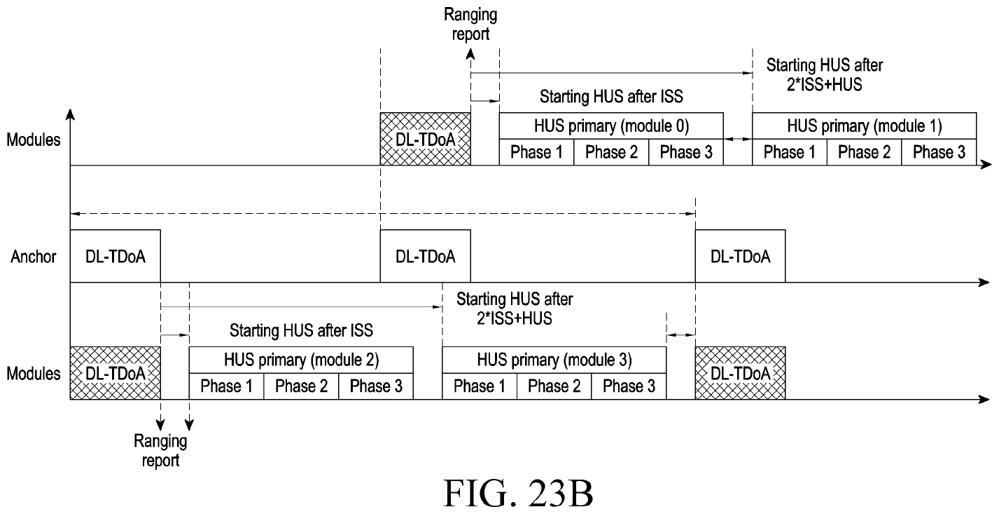

FIGS. 23A and 23B illustrate an example of performing UWB communication in a multi-aisle scenario according to an embodiment of the disclosure.

Referring to FIG. 23A, Aisle #0 may be set between Gate #0 and Gate #1, and Aisle #1 may be set between Gate #1 and Gate #2. For example, the mobile device MD may perform UWB communication with each of the UWB module Module 0 of Gate #0 and the UWB module Module 1 of Gate #1 to perform at least one operation among device discovery, grasping of mutual distance, and payment data transmission around Aisle #0. The mobile device MD may perform UWB communication with each of the UWB module Module 2 of Gate #1 and the UWB module Module 3 of Gate #2 to perform at least one operation among device discovery, grasping of mutual distance, and payment data transmission around Aisle #1.

According to an embodiment, a DL-TDoA period for synchronization on the same frequency channel may be set in some of the plurality of UWB modules of gates.

Referring to FIG. 23B, a DL-TDoA period for synchronization between the anchor, the UWB module Module 0 of Gate #0 and, the UWB module Module 1 of Gate #1 may be set on a first channel (e.g., channel 5). The HUS primary for the UWB module Module 0 of Gate #0 may start, the ISS after the DL-TDoA period. The HUS for the UWB module Module 0 may include three phases. The HUS primary for the UWB module Module 1 of Gate #1 may start, 2*ISS+HUS after the DL-TDoA period. The HUS for the UWB module Module 1 may include three phases.

A DL-TDoA period for synchronization between the anchor, the UWB module Module 2 of Gate #1 and, the UWB module Module 3 of Gate #2 may be set on a second channel (e.g., channel 9). The HUS primary for the UWB module Module 2 of Gate #1 may start, the ISS after the DL-TDoA period. The HUS for the UWB module Module 2 may include three phases. The HUS primary for the UWB module Module 3 of Gate #1 may start, 2*ISS+HUS after the DL-TDoA period. The HUS for the UWB module Module 3 may include three phases.

For example, the DL-TDoA duration may be set to a first time (e.g., 40 ms), the ISS may be set to a second time (e.g., 10 ms), the duration of each Phase may be set to a third time (e.g., 30 ms), and the ranging interval of each HUS session and DL-TDoA may be set to a fourth time (e.g., 240 ms).

According to an embodiment, UCI parameters for a channel switching operation may be defined. According to an embodiment, the channel number CHANNEL NUMBER among the UCI parameters may be used for the first synchronization with the initiator anchor. After synchronizing with the initiator anchor, the responder anchor may switch channels for a multi-channel operation. According to an embodiment, at least one of the UCI parameters may be reused in multi-channel.

TABLE 5

| | Time- | OWR | Contention- | OWR |
|---|---|---|---|---|
| | scheduled | for | based | DL- |
| | TWR | AoA | TWR | TDoA |
| CHANNEL_NUMBER | O | O | O | O |
| RANGING_DURATION | O | O | O | O |
| DL_TDOA_RANGING_METHOD | n.a. | n.a. | n.a. | O |
| DL_TDOA_TO_TIMESTAMP_CONF | n.a. | n.a. | n.a. | O |
| DL_TDOA_HOP_COUNT | n.a. | n.a. | n.a. | O |
| DL-TDOA_MULIT_CHANNEL | n.a. | n.a. | n.a. | O |

Referring to Table 5, for example, among the UCI parameters, CHANNEL NUMBER and RANGING_DURATION may be set in all of Time-scheduled TWR, OWR for AoA, Contention-based TWR, and OWR DL-TDoA. For example, among the UCI parameters, DL_TDOA RANGING METHOD, DL_TDOA_TO_TIMESTAMP_CONF, DL_TDOA HOP_COUNT, and DL-TDOA_MULIT_CHANNEL may be set only in OWR DL-TDoA.

For example, when multi-channel list=[5,9], ranging duration may be a multiple of the number of channels) (e.g., 200 ms). Thereafter, channel switching may occur every 100 ms (200/2).

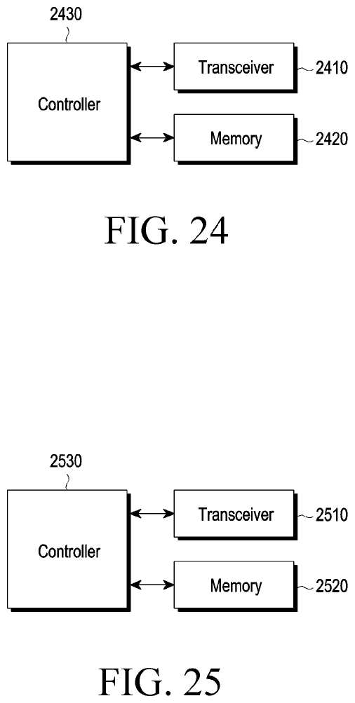

FIG. 24 illustrates a structure of a first UWB device according to an embodiment of the disclosure.

Each of the UWB device, the first UWB device, the gate, the anchor, and the first device transmitter described with reference to FIGS. 1 to 23B may correspond to the first UWB device of FIG. 24. Referring to FIG. 24, the first UWB device may include a transceiver 2410, memory 2420, and a controller 2430.

The transceiver 2410, controller 2430, and memory 2420 of the UWB device may be operated according to the above-described UWB device communication method. However, the components of the UWB device are not limited thereto. For example, the UWB device may include more or fewer components than the above-described components. The transceiver 2410, the controller 2430, and the memory 2420 may be implemented in the form of a single chip. According to an embodiment, the controller 2430 may include at least one processor. According to an embodiment, the controller 2430 may include at least one host.

The transceiver 2410 collectively refers to a transmitter of the UWB device and a receiver of the UWB device and may transmit and receive signals to/from another device. To that end, the transceiver 2410 may include a radio frequency (RF) transmitter for frequency-up converting and amplifying signals transmitted and an RF receiver for low-noise amplifying signals received and frequency-down converting the frequency of the received signals. However, this is merely an example of the transceiver 2410, and the components of the transceiver 2410 are not limited to the RF transmitter and the RF receiver. According to an embodiment, the transceiver 2410 may include a UWBS (e.g., the UWBS 120 of FIG. 1).

The transceiver 2410 may receive signals via a radio channel, output the signals to the controller 2430, and transmit signals output from the controller 2430 via a radio channel.

The memory 2420 may store programs and data necessary for the operation of the UWB device. The memory 2420 may store control information or data that is included in the signal obtained by the UWB device. The memory 2420 may include a storage medium, such as ROM, RAM, hard disk, CD-ROM, and DVD, or a combination of storage media. Rather than being separately provided, the memory 2420 may be embedded in the controller 2430.

The controller 2430 may control a series of processes for the UWB device to be able to operate according to the above-described embodiments.

FIG. 25 illustrates a structure of a second UWB device according to an embodiment of the disclosure.

Each of the UWB device, the second UWB device, the mobile device, the anchor, and the second receiver described with reference to FIGS. 1 to 23B may correspond to the second UWB device of FIG. 25.

Referring to FIG. 25, the second UWB device may include a transceiver 2510, memory 2520, and a controller 2530.

The transceiver 2510, controller 2530, and memory 2520 of the UWB device may be operated according to the above-described UWB device communication method. However, the components of the UWB device are not limited thereto. For example, the UWB device may include more or fewer components than the above-described components. The transceiver 2510, the controller 2530, and the memory 2520 may be implemented in the form of a single chip. According to an embodiment, the controller 2530 may include at least one processor. According to an embodiment, the controller 2530 may include at least one host.

The transceiver 2510 collectively refers to a transmitter of the UWB device and a receiver of the UWB device and may transmit and receive signals to/from another device. To that end, the transceiver 2510 may include a radio frequency (RF) transmitter for frequency-up converting and amplifying signals transmitted and an RF receiver for low-noise amplifying signals received and frequency-down converting the frequency of the received signals. However, this is merely an example of the transceiver 2510, and the components of the transceiver 2510 are not limited to the RF transmitter and the RF receiver. According to an embodiment, the transceiver 2510 may include a UWBS (e.g., the UWBS 120 of FIG. 1).

The transceiver 2510 may receive signals via a radio channel, output the signals to the controller 2530, and transmit signals output from the controller 2530 via a radio channel.

The memory 2520 may store programs and data necessary for the operation of the UWB device. The memory 2520 may store control information or data that is included in the signal obtained by the UWB device. The memory 2520 may include a storage medium, such as ROM, RAM, hard disk, CD-ROM, and DVD, or a combination of storage media. Rather than being separately provided, the memory 2520 may be embedded in the controller 2530.

The controller 2530 may control a series of processes for the UWB device to be able to operate according to the above-described embodiments.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a first ultra-wide band (UWB) device, comprising:
exchanging at least one message for downlink time-difference-of-arrival (DL-TDoA) with a second UWB device in a first period;
receiving, from the second UWB device, a first message for two-way ranging (TWR) in a second period for a hybrid UWB session (HUS); and
transmitting, to the second UWB device, a second message for the TWR in a third period for the HUS,
wherein a different session ID is allocated to each of the second period and the third period, respectively, for the HUS.

2. The method of claim 1, wherein a period for a contention-based ranging (CBR) is set between the second period and the third period for the HUS, and
wherein a length of the period for the CBR is determined based on a processing delay between the first UWB device and a server.

3. The method of claim 1, further comprising transmitting, to the second UWB device, a third message for the TWR in a fourth period for the HUS,
wherein each of the second message and the third message is a message segmented from a single message of the first UWB device.

4. The method of claim 3, wherein each of the second message and the third message includes:
a first parameter indicating that the second message or the third message is a segmented payload; and
a second parameter indicating a segment index of the second message or the third message.

5. The method of claim 3, further comprising receiving, from the second UWB device, a status message indicating whether to receive each of the second message and the third message for the TWR in a fifth period for the HUS.

6. A method of a second ultra-wide band (UWB) device, comprising:
exchanging at least one message for downlink time-difference-of-arrival (DL-TDoA) with a first UWB device in a first period;
transmitting, to the first UWB device, a first message for two-way ranging (TWR) in a second period for a hybrid UWB session (HUS); and
receiving, from the first UWB device, a second message for the TWR in a third period for the HUS,
wherein a different session ID is allocated to each of the second period and the third period, respectively, for the HUS.

7. The method of claim 6, wherein a period for a contention-based ranging (CBR) is set between the second period and the third period for the HUS, and
wherein a length of the period for the CBR is determined based on a processing delay between the first UWB device and a server.

8. The method of claim 6, further comprising receiving, from the first UWB device, a third message for the TWR in a fourth period for the HUS,
wherein each of the second message and the third message is a message segmented from a single message of the first UWB device.

9. The method of claim 8, wherein each of the second message and the third message includes:
a first parameter indicating that the second message or the third message is a segmented payload; and
a second parameter indicating a segment index of the second message or the third message.

10. The method of claim 8, further comprising transmitting, to the first UWB device, a status message indicating whether to receive each of the second message and the third message for the TWR in a fifth period for the HUS.

11. A first ultra-wideband (UWB) device, comprising:
at least one transceiver;
at least one processor communicatively coupled to the at least one transceiver; and
at least one memory, communicatively coupled to the at least one processor, storing instructions executable by the at least one processor individually or in any combination to cause the first UWB device to:
exchange at least one message for downlink time-difference-of-arrival (DL-TDoA) with a second UWB device in a first period;
receive, from the second UWB device, a first message for two-way ranging (TWR) in a second period for a hybrid UWB session (HUS); and
transmit, to the second UWB device, a second message for the TWR in a third period for the HUS,
wherein a different session ID is allocated to each of the second period and the third period, respectively, for the HUS.

12. The first UWB device of claim 11, wherein a period for a contention-based ranging (CBR) is set between the second period and the third period for the HUS, and
wherein a length of the period for the CBR is determined based on a processing delay between the first UWB device and a server.

13. The first UWB device of claim 11, wherein the first UWB device is further configured to transmit, to the second UWB device, a third message for the TWR in a fourth period for the HUS, and
wherein each of the second message and the third message is a message segmented from one message by the first UWB device.

14. The first UWB device of claim 13, wherein each of the second message and the third message includes:
a first parameter indicating that the second message or the third message is a segmented payload; and
a second parameter indicating a segment index of the second message or the third message.

15. The first UWB device of claim 13, wherein the first UWB device is further configured to receive, from the second UWB device, a status message indicating whether to receive each of the second message and the third message for the TWR in a fifth period for the HUS.

16. A second ultra-wide band (UWB) device, comprising:
at least one transceiver;
at least one processor communicatively coupled to the at least one transceiver; and
at least one memory, communicatively coupled to the at least one processor, storing instructions executable by the at least one processor individually or in any combination to cause the second UWB device to:
exchange at least one message for downlink time-difference-of-arrival (DL-TDoA) with a first UWB device in a first period;
transmit, to the first UWB device, a first message for two-way ranging (TWR) in a second period for a hybrid UWB session (HUS); and
receive, from the first UWB device, a second message for the TWR in a third period for the HUS,
wherein a different session ID is allocated to each of the second period and the third period, respectively, for the HUS.

17. The second UWB device of claim 16, wherein a period for a contention-based ranging (CBR) is set between the second period and the third period for the HUS, and
wherein a length of the period for the CBR is determined based on a processing delay between the first UWB device and a server.

18. The second UWB device of claim 16, wherein the second UWB device is further configured to receive, from the first UWB device, a third message for the TWR in a fourth period for the HUS, and
wherein each of the second message and the third message is a message segmented from a single message of the first UWB device.

19. The second UWB device of claim 18, wherein each of the second message and the third message includes:
a first parameter indicating that the second message or the third message is a segmented payload; and
a second parameter indicating a segment index of the second message or the third message.

20. The second UWB device of claim 18, wherein the second UWB device is further configured to transmit, to the first UWB device, a status message indicating whether to receive each of the second message and the third message for the TWR in a fifth period for the HUS.
